(19) United States
(12) Patent Application Publication
(10) Pub. No.: US 2017/0326861 A1
(43) Pub. Date: Nov. 16, 2017

(54) COMPOSITE LAMINATED OBJECT MANUFACTURING USING SELECTIVELY INHIBITED LAMINATION

(71) Applicant: Global Filtration Systems, a dba of Gulf Filtration Systems Inc., Dearborn Heights, MI (US)

(72) Inventors: Ali El-Siblani, Dearborn Heights, MI (US); Alexandr Shkolnik, Los Angeles, CA (US)

(21) Appl. No.: 15/151,602

(22) Filed: May 11, 2016

(51) Int. Cl. B32B 37/06; B32B 37/00; B32B 37/10

(52) U.S. Cl. CPC B32B 37/06; B32B 37/10; B32B 37/0053; B32B 2250/02

(57) ABSTRACT

Methods and apparatuses for making laminated objects from composite materials are shown and described. An adhesion reducing material is applied with a moving printhead to the interfaces between object sections and waste sections of the layers of the objects to facilitate damage-free removal of the waste sections from the object sections. A rotating build platform allows the objects to be formed with the fibers of adjacent layers oriented at non parallel rotational orientations relative to one another. In certain examples, the adhesion reducing material is applied between opposing surfaces of layers wherein one surface is an object surface and the opposing surface is a waste surface. An infrared preheater preheats the side of a current layer being applied to a previous layer to a temperature sufficient to cause the composite adhesive to bond layers together. The infrared preheater and a pressure roller define a lamination assembly that traverses along a travel axis during a lamination operation.

### FIELD

The disclosure relates to a system and method for manufacturing laminated composites by selectively inhibiting lamination within a layer and between two adjacent layers.

### DESCRIPTION OF THE RELATED ART

Three-dimensional rapid prototyping and manufacturing allows for quick and accurate production of components at high accuracy. Machining steps may be reduced or eliminated using such techniques and certain components may be functionally equivalent to their regular production counterparts depending on the materials used for production.

The components produced may range in size from small to large parts. The manufacture of parts may be based on various technologies including photo-polymer hardening using light or laser curing methods. The present disclosure is directed to laminated object manufacturing (“LOM”), and in particular LOM using composite materials.

LOM uses sheet materials to make three dimensional objects, which allows for making parts out of pre-existing off-the-shelf sheet materials. LOM creates 3D parts by forming individual layers out of pre-existing sheet materials by cutting or etching them in patterns dictated by data representative of the three-dimensional object being built. The layers are adhesively bonded together. Each layer is cut or etched into object sections and waste sections. The object sections are those sections of the layer that define the desired finished object. The waste sections are those sections of the layer other than the object sections and are removed at the end of the object building process.

Current LOM systems and methods suffer from a number of drawbacks. Certain LOM methods cut object shapes out of the laminating material before adhering layers together. These methods require techniques for aligning or “registering” the various layers. Also, many methods require the inclusion of a process for depositing an adhesive onto the laminating material.

After LOM layers are formed to define the desired object cross-section, the layers include an object section that will remain part of the finished object and waste sections that will be removed. The object sections and waste sections define interfaces where the two sections meet. The waste sections are typically cut or etched to facilitate their removal from the finished object. However, within a given layer, the waste sections can sometimes adhere to the object sections such that removal of the waste sections damages the object sections. Also, adjacent layers may have regions where object sections in one layer abut waste sections in another layer. As a result, the removal of the waste sections in one of the layers can damage an adjacent object section in an adjacent layer.

Another drawback in many known LOM processes involves the use of a pressure roller to bond adjacent layers. In some cases, the pressure roller comes into contact with the adhesive at a temperature high enough for adhesion to the roller itself to occur. This is particularly a problem if the pressure roller itself is used to supply the heat necessary for adhesion and lamination to occur. In addition, many prior LOM processes failed to account for the compression of laminating materials when moving the build platform to laminate subsequent layers. Certain laminating materials such as those with a plastic binder component will undergo compression during a lamination operation, and if the build platform is moved by a distance corresponding to the uncompressed thickness of the layer, the mechanical properties of the resulting object may be compromised and/or delamination may occur.

Thus, a need has arisen for an apparatus and method for making laminated objects from composite materials which addresses the foregoing issues.

### BRIEF DESCRIPTION OF THE DRAWINGS

The disclosure will now be described, by way of example, with reference to the accompanying drawings, in which:

FIG. 1A is a perspective view of a laminated object manufacturing apparatus in an assembled state;

FIG. 1B is an exploded view of the laminated object manufacturing apparatus of FIG. 1A;

FIG. 1C is a top plan view showing a layer of an anisotropic reinforced fiber plastic that was most recently laminated during an object manufacturing process after being cut to form an object section and a waste section with the fibers in a first rotational orientation in the x-y plane;

FIG. 1D is a top plan view of the layer of FIG. 1C following the rotation of the build platform with the fibers in a second rotational orientation in the x-y plane;

FIG. 1E is top plan view of a new layer laminated on the layer of FIG. 1D before being cut to form an object section and a waste section with the fibers in the first rotational orientation in the x-y plane of FIG. 1C;

FIG. 2 is a side elevation view of a pressure-roller sub-assembly of the lamination assembly used in the laminated object manufacturing apparatus of FIG. 1A in a laminating configuration;

FIG. 3 is a side elevation view of a schematic of a material handling system used in the laminated object manufacturing apparatus of FIG. 1A;

FIG. 4 is a perspective view of a material advancement system useful in the material handling system of FIG. 3;

FIG. 5 is a side elevation view of the pressure roller sub-assembly of FIG. 2 in a retracted (non-laminating) configuration with the material advancement system of FIG. 4 extended therethrough and gripping a free edge of a composite material;

FIG. 6A is a perspective view of a cutting assembly useful in the laminated object manufacturing apparatus of FIG. 1A;

FIG. 6B is a side cross-sectional view of the cutting assembly of FIG. 6A;

FIG. 7 is a side elevation schematic view of the cutting assembly of FIG. 6A connected to an adhesion reducing material printhead used in the laminated object manufacturing apparatus of FIG. 1A;

FIG. 8 is an exaggerated side cross-sectional view of the adhesion reducing material printhead of FIG. 7;

FIG. 9A is a schematic view of two layers of a laminated object showing an adhesion reducing material applied to a portion of an inter-layer interface between a waste material section in one layer and an object material section in an adjacent layer prior to a waste cutting operation;

FIG. 9B is a schematic view of the two layers of FIG. 9A following a waste cutting operation;

FIG. 9C is a schematic view of two layers of a laminated object with an adhesion reducing material applied to a portion of a region of one layer beneath an overhang of an adjacent layer's object section;

FIG. 10 is a flow diagram depicting a method of making a three-dimensional object from a composite material which comprises applying an adhesion reducing material between object and waste sections within a layer of the object;

FIG. 11 is a flow diagram depicting a method of making a three-dimensional object from reinforce fiber plastic materials with alternating layers having different orientations of the fiber lengths relative to one another; and

FIG. 12 is a flow diagram depicting a method of making a three-dimensional object from a composite material which comprises applying an adhesion reducing material between object and waste sections within a layer of the object and between adjacent layers of an object.

### DETAILED DESCRIPTION

The Figures illustrate examples of a system and method for manufacturing. Based on the foregoing, it is to be generally understood that the nomenclature used herein is simply for convenience and the terms used to describe the invention should be given the broadest meaning by one of ordinary skill in the art. Unless otherwise specified, like numerals refer to like components herein.

The system and methods described herein are generally applicable to the laminated manufacturing of three-dimensional objects, such as components or parts (discussed herein generally as objects), but may be used beyond that scope for alternative applications. In such systems and methods, successive layers of an object forming material are adhered to one another and cut in a pattern that defines an object section and a waste section. The patterns are based on data representative of the three-dimensional object. The data may be provided, for example, as CAD/CAM data and sliced into a number of layers (using a data slicing technique) each representing a cross-section of the object. Any known three-dimensional object data construct may be used, including without limitation STL (Stereo Lithography) files or other CAD (Computer Aided Drafting) files commonly translated for rapid prototyping systems into formats such as SLC, CLI slice data files or voxelized data files which may include data formats such as BMP, PNG, and vector data that defines the object contours within each layer. In preferred examples, the three-dimensional object data is preferably converted to layer data and then to a format (such as G-Code data) useful for moving the cutting assembly 56 in the x-y plane, adjusting the z-axis position of the blade 140 tip and adjusting the rotational orientation of the blade 140 about its own longitudinal axis. In certain preferred examples, the patterns are based on G-Code data and used to guide the movement of a cutting blade that forms the contours of the object sections and cuts the waste sections into shapes that facilitate their separation from the object sections.

Preferred materials for making three-dimensional objects in accordance with the present disclosure include composite materials, and more specifically, reinforced fiber plastics. Composite materials are combinations of two or more chemically distinct and insoluble phases with a recognizable interface, in such a manner that its properties and structural performance are superior to those of the constituents acting independently. One class of composites of particular importance in this disclosure is reinforced fiber plastics, also known as polymer-matrix composites, and fiber-reinforced plastics. This class of composite materials includes fibers as a discontinuous or dispersed phase in a polymer matrix. The fibers tend to have high specific strength (strength to weight ratio) and specific stiffness (stiffness to weight ratio). The fibers have stiffness in the longitudinal direction but very little strength or stiffness in the direction transverse to the longitudinal direction. The reinforced fiber plastics comprise a polymer matrix of a thermoset or thermoplastic polymer with reinforcing fibers embedded therein. The percentage of fibers in reinforced plastics generally ranges from 10 percent to 60 percent (by volume). In some cases, the fibers are istotropic, and in other cases, the fibers are anisotropic. The thermoset or thermoplastic polymer acts a binder (adhesive) when it is heated above a lamination temperature and cooled to adhere adjacent object layers to one another.

In certain examples, the reinforced fiber plastics are provided as pre-peg (“pre-impregnated”) sheets comprising fibers in a polymeric matrix of a thermoplastic or thermosetting binder. The fibers are pre-impregnated with the binder, and the binder can be heated to act as an adhesive for laminating adjacent layers together. The advantage of using pre-pegs as laminating materials is that the apparatus for making the three-dimensional object does not have to include an apparatus for depositing a separate adhesive onto the laminating materials, which reduces equipment costs and processing times.

Pre-pegs may have continuous fibers or discontinuous fibers. Continuous fibers are those that have an uninterrupted length along some dimension of the sheet (e.g., length, width, or some angled orientation between the length and the width). Discontinuous or “chopped” fiber pre-pegs are short (relative to the sheet dimensions) and are randomized as to their placement and orientation. Pre-pegs are generally made in one of three ways: 1) laminating one side of the fibers with a binder, 2) laminating both sides of the fibers with a binder, and 3) powder coating the fibers with a binder.

Pre-pegs are typically classified as “isotropic” or “anisotropic.” An isotropic pre-peg has equal mechanical properties in any direction along any axis. An anisotropic pre-peg will have some directional variation in mechanical properties. Anisotropic pre-pegs may have fibers that are uni-directional, bi-directional, and multi-directional. There may be two or more axes along an anisotropic pre-peg along which the mechanical properties will be equal. However, there will also be one or more axes along which the properties will be unequal. Discontinuous, randomly-oriented fiber pre-pegs are isotropic. Continuous fiber pre-pegs are anisotropic. However, if they are multi-directional, as the number of fiber directions increases, the pre-pegs will generally approach anisotropy.

In some examples, the pre-pegs have anisotropic fibers which provide mechanical properties that vary with direction. In one example, the anisotropic fibers are parallel to one another throughout the entirety of the sheet. However, in other examples, groups of fibers with in the pre-pegs are oriented at different angles relative to one another in a way that provides for some variation in mechanical properties as between two different axes. For example, if two groups of fibers are provided and are oriented at ninety degrees relative to one another, the properties at forty-five degrees will vary from those at zero degrees and ninety degrees. As will be discussed further below, adjacent layers containing anisotropic fibers may be oriented with the fibers at different rotational orientations relative to one another to obtain a desired object strength or other desired mechanical properties.

Suitable thermoplastic matrix materials for use in making reinforced fiber plastics (including pre-pegs) in accordance with the present disclosure include HDPE (high density polyethylene), LDPE (low density polyethylene), polypropylene, Nylon 6, Nylon 66, polycarbonate polyetherketone ketone (PEKK), and polyetherether ketone (PEEK). Suitable thermoset materials include epoxies, polyesters, phenolics, fluorocarbons, polyethersulfone, silicone, and polyimides. Once thermoset materials cure, they cannot be reheated to flow. Therefore, when composite materials comprising thermosets are used, steps are preferably taken to prevent curing from occurring before lamination. In one example, a release liner with a release coating, such as a silicone coated paper, is placed over the composite material to protect the thermoset from atmospheric exposure. The release liner is removed as close in time to the layer being laminated to the three-dimensional object as possible. In addition, it is often necessary to keep composite materials comprising thermosets at a relatively cold temperature to avoid premature thermal curing.

Suitable reinforcing fibers include glass, carbon, graphite, boron, and aramid (Kevlar) fibers. Carbon nanotubes may also be used to form a composite instead of using carbon fibers. Carbon nanotubes are seamless, cylindrical hollow fibers comprised of a single sheet of pure graphite that typically have a diameter of 0.7 to 50 nanometers and lengths in the range of 10 s of microns.

In certain examples herein, a PEEK carbon fiber fabric is used. In one implementation thereof, the PEEK carbon fiber fabric has a glass transition temperature of about 289° F. (143° F.). PEEK carbon fiber fabrics are particularly well suited for aircraft applications due to their strength, light weight, and chemical and corrosion resistance to typical aircraft service fluids.

The ability to form three dimensional objects by laminating composite materials comprising reinforced fiber plastics provides superior mechanical properties (e.g., tensile strength, tensile modulus, flexural strength, flexural modulus, Izod impact, compression strength, compression modulus, and shear strength) as compared to current rapid prototyping technologies. In certain examples herein, the reinforced fiber plastics are anisotropic and alternate layers are arranged such that the length axes defined by their fibers are not parallel. This alternating of the fiber lengths further improves object strength.

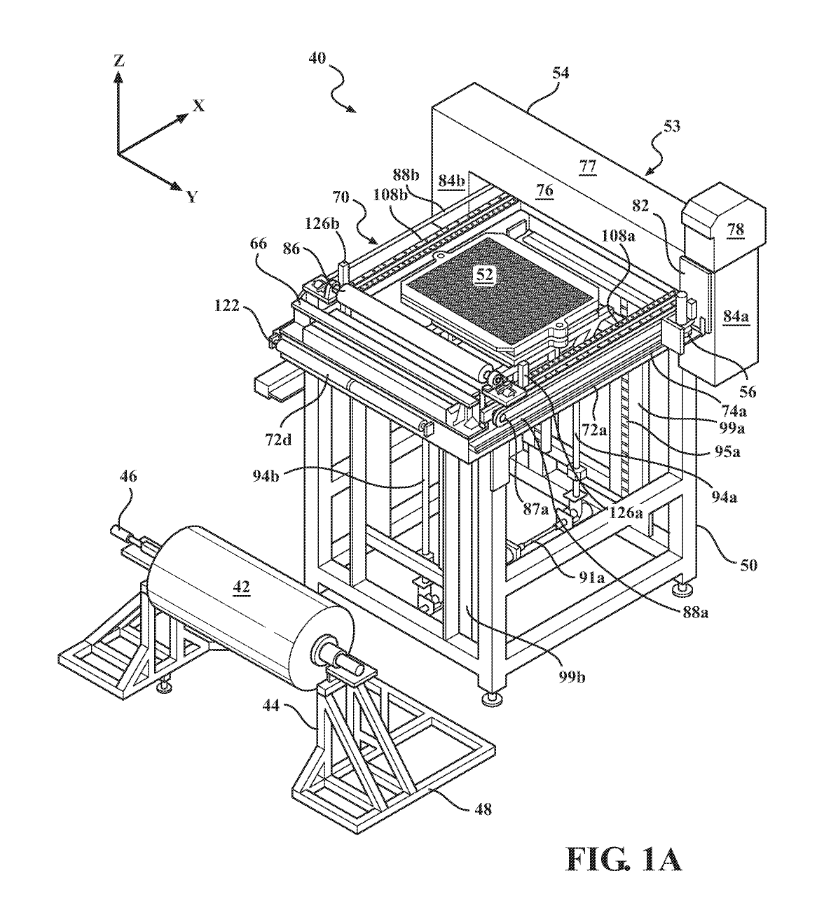

Referring to FIGS. 1A and 1B, an apparatus 40 for making a three-dimensional object by laminating composite materials is shown. Apparatus 40 may be used to laminate types of materials other than composites, including without limitation plastic films or sheets such as rigid PVVC, styrene, polycarbonate, polypropylene, and ABS, as well as waxes and metal foils. However, apparatus 40 preferably does not include an adhesive deposition apparatus. As a result, preferred laminating materials include composite materials comprising thermoset or thermoplastic phase that can be heated to act as an adhesive. Reinforced fiber plastics are especially preferred. In certain examples, the laminating materials that are used are sheets of pre-pegs.

Apparatus 40 comprises a table lift 50 that holds a rotary table 98 (FIG. 1B) on which a build platform 52 is mounted. The three-dimensional object (not shown) is built on the build platform 52. Build platform 52 progressively moves downward along the build (z) axis during an object building operation as the three-dimensional object grows in height along the build (z) axis.

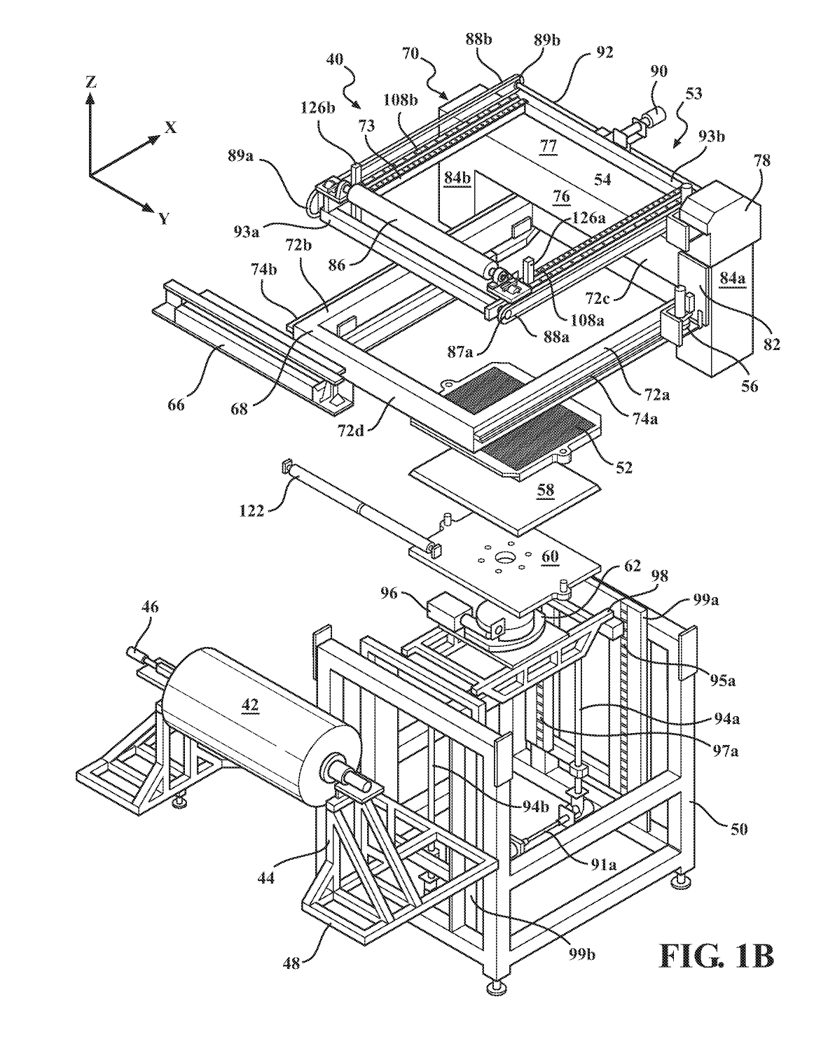

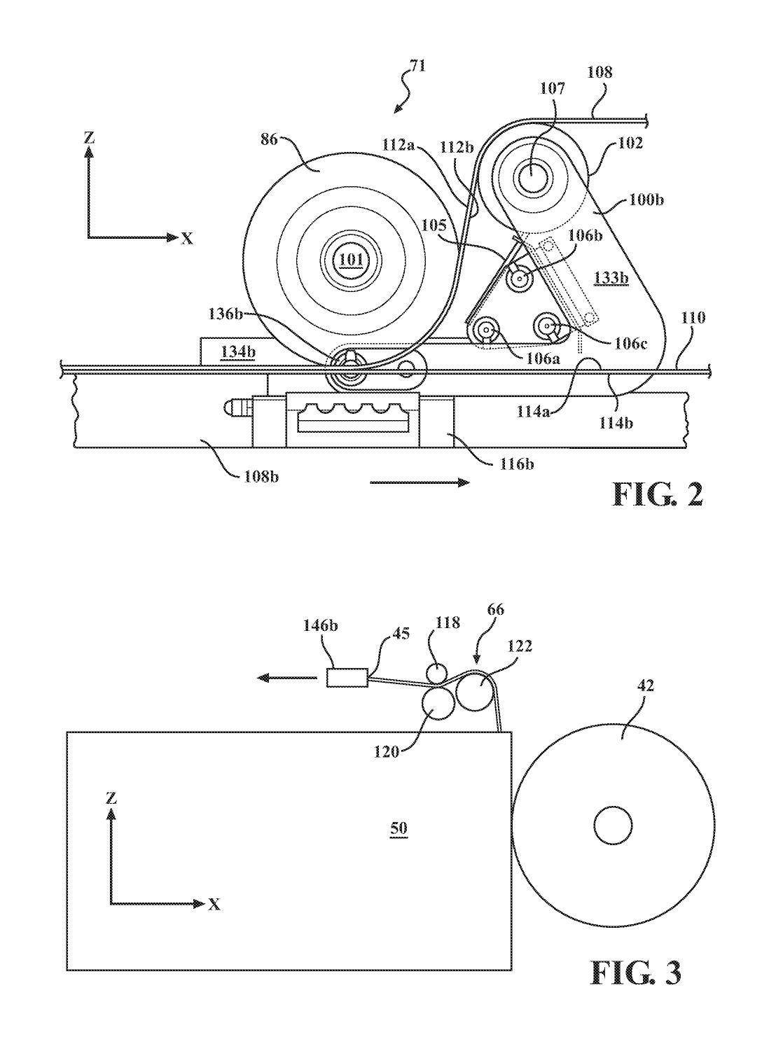

A lamination assembly 70 is provided and is used to bind successive layers of laminating material 42 to one another. Material handling system 66 provides a free edge of laminating material 42 that can be gripped by a pair of parallel material advancement systems 124a and 124b (FIG. 4) which pulls the free edge of the laminating material 42 along the travel (x) axis away from the material handling system 66 and onto the build platform 52. Lamination assembly 70 includes a pressure roller subassembly 71 shown in FIG. 2.

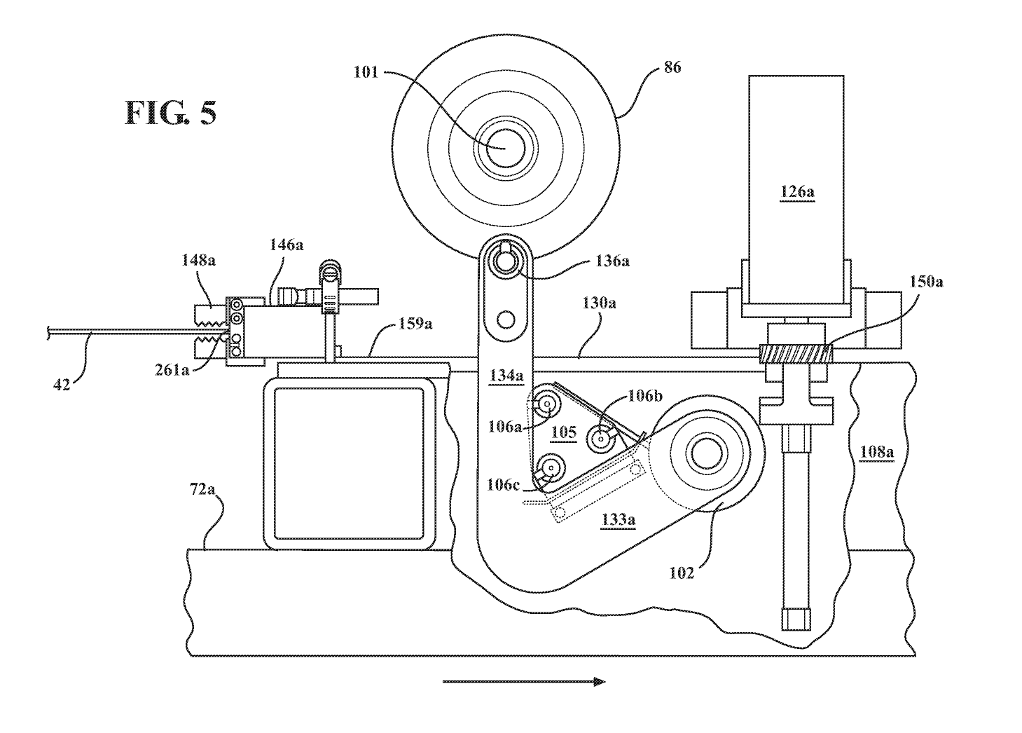

A laminating material forming assembly 53 is also provided to form the laminating material 42 into shapes dictated by data representative of the three dimensional object being built. Laser assemblies and cutting assemblies may be used as forming assemblies. In the figures, the laminating material forming assembly 53 comprises cutter translation assembly 77 and a cutting assembly 56 (FIGS. 6A and 6B). Cutting assembly 56 comprises a blade 140 that quickly reciprocates along the build (z) axis during cutting operation. In certain examples, the blade 140 reciprocates at ultrasonic frequencies along the build (z) axis.

In general, the cutting assembly 56 cuts sheets of laminating material 42 into object sections corresponding to the three-dimensional object being built and waste sections which comprise those portions of a sheet of laminating material 42 which are not object sections. The waste sections are typically cut into a pattern that facilitates their removal once the object building process is complete. In one example, the pattern is cubes. The object sections may be defined by vector data that is used to dictate the movement of the blade 140. One advantage of the LOM methods of the present disclosure relative to other methods such as stereolithography, is that rasterization need not be carried out to solidify the areas within the object sections. Instead, only the object contours need to be formed.

Referring again to FIGS. 1A and 1B the laminating material 42 is provided on a spool 46 which rotates to feed a free edge (not shown) of the laminating material 42 to material advancement assembly 124 (FIG. 4) which pulls the free edge along the travel (x) axis. The spool 46 is attached to a vertical support structure 44 which is in turn attached to a base 48.

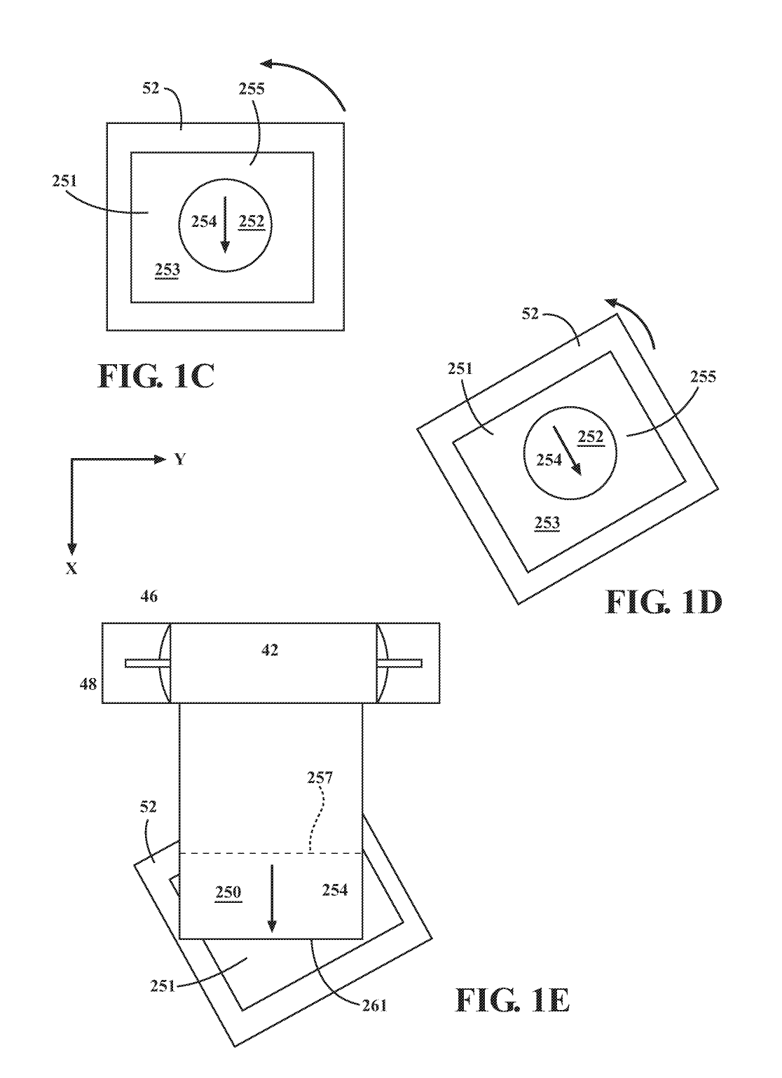

An exaggerated schematic view of the material handling assembly 66 is shown in FIG. 3. Material handling assembly 66 comprises a drive roller 118, a feed roller 120, and a guide roller 122. The drive roller 118, feed roller 120, and guide roller 122 each rotate about their own longitudinal axes but do not travel along the travel (x) axis. The three rollers 118, 120, and 122 provide a way of holding onto the free end 45 of the laminating material 42 and facilitating the smooth advancement of free end 45 along the travel (x) axis.

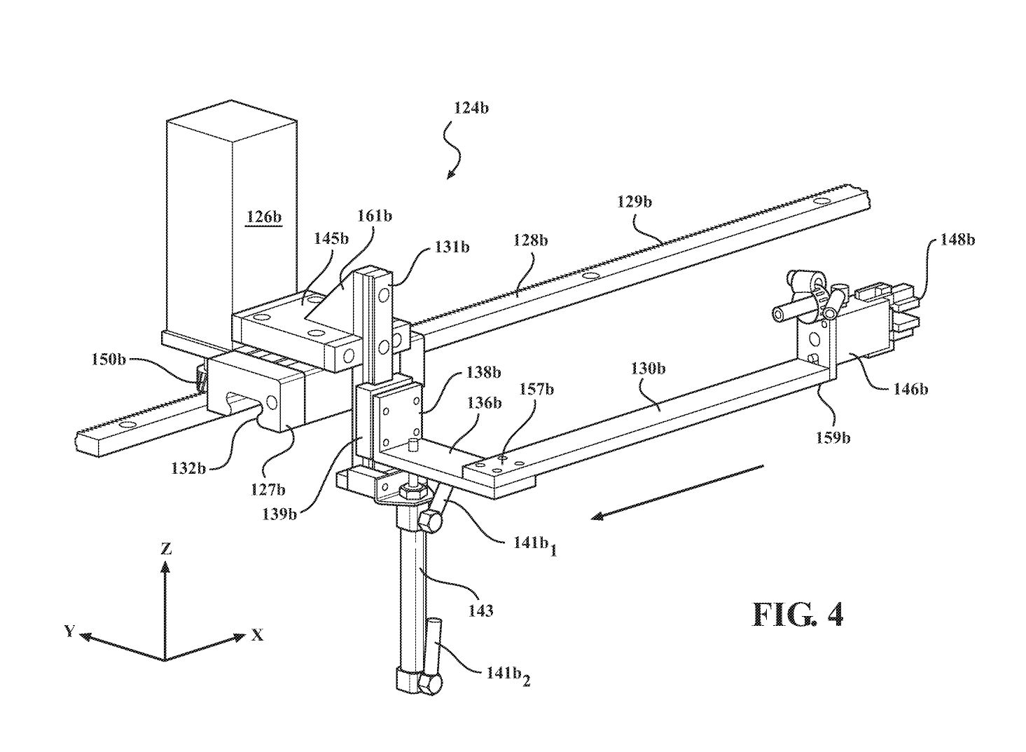

Apparatus 40 includes two material advancement assemblies 124a and 124b to pull a free edge of laminating material 42 over build platform 52 to laminate each layer. Material advancement assembly 124b is shown in FIG. 4 and advances in the direction shown by the arrow to pull laminating material along the travel (x) axis across the build platform 52. However, a parallel material advancement assembly 124a is provided which includes the same components as a material advancement assembly 124b. Material advancement assembly 124a is shown in FIG. 5.

Material advancement assembly 124b (FIG. 4) comprises gripper 146b. Gripper 146b travels along the travel (x) axis to pull the free edge 45 of laminating material 42 to a desired travel (x) axis location on build platform 52. In preferred examples, the desired location is the edge of the “build envelope.” The build envelope comprises the area within the build platform 52 where the three dimensional object (including removable waste sections) is built. It is typically a rectangular area inward from the edges of build platform 52. The y-axis location of laminating material 42 is fixed by the y-axis position of the roll on spool 46 and the width of the laminating material on the spool 46. A gripper 146 is provided and grips the free end 45 of laminating material 42.

Referring again to FIG. 4, gripper 146b is selectively activatable to travel along the travel (x) axis and to open and close gripping jaws 148b to selectively clamp down on and release the free edge of laminating material 42. Material advancement assembly 124b comprises a rack gear 128b that engages a pinion gear 150b. It also comprises an elongated arm 130b which includes gripper 146b at its distal end 159b. A proximal end 157b of elongated arm 130b is connected to a vertical positioning rail 131b via horizontal bracket 136b and vertical bracket 138b. Vertical bracket 138b is connected to a linear bearing 139b that slidingly engages vertical rail 131b to adjust the build (z) axis position of elongated arm 130b and gripper 146b. Handles 141b1 and 141b2 are attached to a shaft (not shown) in housing 143b and lock the shaft into place, thereby locking the linear bearing 139b into place to secure the build (z) axis position of elongated arm 130b and gripper 146b.

Vertical rail 131b is connected to another linear bearing 127b via mounting plate 145b and bracket 161b. Linear bearing 127b slidingly engages a laminating assembly rail 108b (FIG. 1B and FIG. 2) which extends along the travel (x) axis. Rack gear 128b is fixedly attached to the laminating assembly rail 108b.

Rack gear 128b is an elongated rail structure that includes teeth 129b which engage corresponding teeth on pinion gear 150b. Motor 126b selectively activates pinion gear 150b, causing pinion gear 150b to rotate about an axis of rotation through its center which is parallel to the build (z) axis. As pinion gear 150b rotates, the engagement of its teeth with rack gear teeth 129b causes linear bearing 127b to travel along the travel (x) axis. The material advancement assembly 124b is not visible in FIGS. 1A and 1B. However, linear bearing opening 132b fits over laminating assembly rail 108b so that linear bearing 127 slidingly engages and rides along laminating assembly rail 108b as the pinion gear 150b rotates. As a result, elongated arm 130b and gripper 146b translate along the travel (x) axis. An actuating assembly is also provided but not separately shown to open and close gripper jaws 148b.

Laminating assembly 70 (FIGS. 1A and 1B) comprises a laminating assembly horizontal frame 73 (FIG. 1B) that includes side rails 108a and 108b and front and rear frame members 93a and 93b. Rails 108a and 108b are spaced apart along the y axis and connected by front and rear frame members 93a and 93b which are spaced apart along the travel (x) axis. As best seen in FIG. 1A, timing belts 88a and 88b (which may be chain belts) are spaced apart along the travel (x) axis and circulate to move pressure roller 86, guide roller 102 and preheat assembly 105 along the travel (x) axis. Timing belt 88a is connected to pulleys 87a and 87b (not shown) which are spaced apart along the travel (x) axis. Timing belt 88b is attached to pulleys 89a and 89b which are spaced apart along the travel (x) axis. Laminating assembly motor 90 (FIG. 1B) is selectively activatable to rotate shaft 92 about its longitudinal axis, which is parallel to the y-axis. Pulleys 87b (not shown) and 89b are mounted on shaft 92 which is parallel to the y-axis. As shaft 92 rotates, pulleys 89b and 87b (not shown) rotate, causing the timing belts 88a and 88b to circulate, which translates the pressure roller 86, guide roller 102 and preheater assembly 105 along the travel (x) axis (FIG. 2). As the pressure roller 86, guide roller 102, and preheater assembly 105 translate, they apply heat and pressure to laminate a current layer 108 (FIG. 2) of laminating material 42 to a previous layer 110 of laminating material 42, thereby adhering the two layers 108 and 110 together.

Referring to FIG. 2, pressure roller sub-assembly 71 comprises a moving pair of brackets 100a (not shown) and 100b which include corresponding horizontal sections 134a (not shown) and 134b and vertically-angled sections 133a (not shown) and 133b. The brackets 100a and 100b are spaced apart along the y axis. Pressure roller sub-assembly 71 is part of laminating assembly 70 and also includes pressure roller 86, guide roller 102, preheater assembly 105 and linear bearings 116a (not shown) and 116b.

Pressure roller 86 is mounted on a shaft (not shown) through opening 101 that defines a longitudinal axis that is parallel to the y-axis and about which pressure roller 86 rotates as it translates along the travel (x) axis. Guide roller 102 is mounted on a shaft (not shown) through opening 107 that defines a longitudinal axis that is parallel to the y-axis and about which guide roller 102 rotates as it contacts current laminating material layer 108. The bracket 100b is attached to a linear bearing 116b which slidingly engages rail 108b. A corresponding bracket 100a and linear bearing 116a are provided on the opposite side of the build platform 52 along the y-axis. The linear bearings 116a and 116b are operatively connected to the timing belts 88a and 88b such that when the timing belts 88a and 88b (FIG. 1B) circulate, the linear bearings 116a and 116b slide along corresponding rails 108a and 108b. As shown in FIG. 2, during a lamination operation, a lower surface 112b of current laminating material layer 108 is in contact with the outer surface of guide roller 102. An upper surface 112a of current laminating material layer 108 is in contact with pressure roller 86. During a lamination operation, the pressure roller sub-assembly 71 is oriented as shown in FIG. 2 with the longitudinal axis (through the center) of guide roller 102 spaced above and apart from the longitudinal axis (through the center) of pressure roller 86 along the build (z) axis. The guide roller 102 and pressure roller 86 move along the travel (x) axis with the guide roller 102 leading the pressure roller 86 as indicated by the rightward pointing arrow in FIG. 2. Thus, as pressure roller 86 rolls and translates along the travel (x) axis, it applies pressure to the upper surface 112a of current laminating material layer 108, pressing the current laminating material layer 108 into previous laminating material layer 110.

Preheater assembly 105 is also provided as part of lamination assembly 70 to apply heat to the lower surface 112b of current laminating material layer 108 prior to the lower surface 112b of current laminating material layer 108 making contact with the upper surface 114a of previous laminating material layer 110. The preheater assembly 105 comprises at least one preheater, which in FIG. 2 is three preheaters 106a, 106b, and 106c. The preheaters 106a, 106b, and 106c are generally cylindrical in shape and have lengths that extend along the y-axis. In certain preferred examples, the preheaters 106a-106c are infrared (IR) preheaters that transmit infrared energy to lower surface 112b of current laminating material layer 108 and to upper surface 114a of previous laminating material layer 110. A non-contact temperature sensor is used to measure the temperature of the lower surface 112b of current laminating material at or adjacent the “junction” where the lower surface 112b of current layer 108 and the upper surface 114a of previous layer 110 make contact (at the lower most point of the pressure roller 86). Suitable non-contact temperature sensors include infrared temperature sensors supplied by Exergen Corporation. When using composite materials with electrically conductive fibers, preheaters 106a-106c may also comprise inductive heaters that apply high frequency EMF to the upper surface 114a of current laminating material layer 108. The inductive heaters may be configured similarly to the infrared preheaters 106a-106c shown in FIG. 2. The advantage of using inductive heaters is that the EMF will not directly heat the binder material if it is not electrically conductive. Instead, the electrically conductive fibers will heat up and will then heat the binder via thermal conduction. In general, this provides a more controlled way of evenly heating the binder than relying on heaters that heat the binder directly via radiation or conduction. Carbon fibers are one example of an electrically conductive fiber for which inductive heaters are suitable. In contrast, fiberglass fibers are insulating and are not suitable for inductive heating.

The amount of heat supplied by preheaters 106a-106c is sufficient to cause the polymer matrix component of a reinforced fiber plastic to reach a lamination temperature, i.e., a temperature at which the plastic of the current and previous laminating material layers 108 and 110 is soft and hot enough to cause adhesive bonding between the lower surface 112a of current laminating material layer 108 and upper surface 114a of previous laminating material layer 110.

Pressure roller 86 comprises a heat conductive material, preferably a metal such as steel or aluminum. Pressure roller 85 houses a conductive heating coil used to selectively heat the outer surface of pressure roller 86. The outer surface of pressure roller 86 will generally supply less heat to upper surface 112a of current laminating material layer 108 than the preheaters 106a-104c will supply to lower surface 112b of current laminating material layer 108 so that the current laminating material layer 108 does not adhere to the outer surface of pressure roller 86. In certain known systems, all of the lamination heat is supplied by a pressure roller to the upper surface 112a, which causes the composite material to adhere to pressure roller 86. In preferred examples, the surface temperature of pressure roller 86 is maintained below the glass transition temperature of laminating material 42 so that the upper surface 112a of current layer 108 does not adhere to the pressure roller 86. In certain examples, the surface of pressure roller 86 is maintained at a controlled temperature by using a thermocouple or other temperature measuring device that measures the temperature of the external surface of the pressure roller 86 and adjusting the heat supplied by the conductive heating coil in pressure roller 86 (such as by adjusting the current or voltage supplied to the coil). Feed back control may also be used with preheaters 106a-106c by measuring their emission temperatures and adjusting the energy supplied to the preheaters 106a-106c (e.g., by adjusting the source voltage or current supplied to the preheaters 106a-196c. Alternatively, as indicated above, non-contact temperature sensors (such as IR temperature sensors) may provide a temperature of the lower surface 112b of current laminating material layer 108 and used to manipulate the heat supplied by preheaters 106a-106b. In certain examples, pressure roller 86 is used to apply a controlled pressure to upper surface 112a of current laminating material layer 108. A shaft (not shown) through opening 101 may be operatively connected at its ends to pressure sensors, and the position of build platform 52 along the build (z) axis may be manipulated to achieve a desired pressure. In such examples, the shaft is operatively connected to the side rails 108a and 108b so that pressure roller 86 has some play in the build (z) axis direction. Although not visible in FIG. 2, lower surface 114b of previous laminating material layer 110 is adhered to a prior previous layer of laminating material 42 (or to build platform 52 if previous laminating material layer 110 is the first object layer).

After each layer of laminating material 42 is adhered to the previous layer, a forming operation takes place. In some known LOM processes, the forming operation takes place before adhering the layers together. However, such processes generally require a means for aligning or registering the formed object sections. By adhering the layers before carrying out the forming operation, the forming operation may be carried out with respect to the same fixed frame of reference in the x-y plane without the need to make sure the layers are registered.

In general, it is desirable to maintain a constant layer thickness as between different layers when laminating layers of a particular composite material. Pre-peg composite materials will have a laminated (compressed) thickness that may be substantially thinner than the unlaminated pre-peg thickness. Variations in the laminated thickness throughout an object may cause undesirable mechanical property variations. In addition, the build platform 52 should ideally be moved downward by an amount Δz that is equal to the amount of the actual compressed thickness of the current layer not the uncompressed thickness, which is greater. If the build platform 52 is moved down by a distance greater than the actual compressed thickness of the current layer, the mechanical properties of the three-dimensional object may be compromised and/or delamination may occur.

A default compressed layer thickness (such as one provided by the supplier of laminating material 42) may initially be used to determine how far down along the build (z) axis to move the build platform 52 after each layer is formed. The compressed layer thickness is the thickness expected at a certain pressure and temperature applied to the layer. In the same or other examples, the actual compressed layer thickness is used after the default thickness is used for the first layer or some initial number of layers. In certain examples, the build platform 52 is moved downward by a distance equal to the measured thickness of the previous layer. In other examples, the build platform 52 is moved down by a distance equal to an average thickness of several previous layers. In further examples, the average is a sliding window average wherein a defined number of thickness measurements is used to determine the average thickness, and as new layers are formed, earlier measured thicknesses outside of the window are discarded in the averaging calculation. In certain examples, platform 52 is moved by a certain amount to affect a desired change in the downward (along the build (z) axis) pressure applied by pressure roller 86 to achieve a desired layer thickness.

A contact sensor (not shown) such as a button may be provided on pressure roller 86 and used to determine the compressed layer thickness of each layer following lamination. Following the completion of a layer, the build platform 52 is elevated until contact is made with the sensor. Instead of using a contact sensor, the pressure sensors used for pressure roller 86 may also be used by lowering the build platform 52 until the object is exerting no upward force on the pressure roller 86 and then elevating the platform 52 until a pressure change is detected. The contact with the sensor (or the change in pressure) defines a specific build (z) axis location of the upper surface of the most recently formed object layer relative to the earth and the stationary components of apparatus 40. When the next layer is built, the process is repeated. The build platform 52 also has a position detector (or the position may be determined by the operation of the actuating mechanism used to raise and lower the build platform 52) so that the build platform positions between the two sensor contact events (or two pressure change events) may be used to determine the thickness of the most recently formed layer. In certain examples, the currently detected layer thickness is used to manipulate certain build parameters (discussed below) to drive the layer thickness toward the nominal compressed layer thickness for the lamination material 42 (which may be provided by the material supplier). However, in other examples, a sliding window average of the layer thicknesses is determined by using a specified number of the most recent thickness measurements and discarding those measurements that preceded the specified number. The sliding average is then compared to the nominal or set point value of the compressed layer thickness and used to adjust build parameters to drive the operation toward the nominal value.

Several different variables may be manipulated to control the layer thickness and drive it toward a desired or set-point value. The variables may be manipulated separately or in combination, and in various sequences. One of the variables is the pressure applied by pressure roller 86. The pressure may be manipulated by changing the distance Δz by which build platform 52 drops after laminating a layer. The lower the value of Δz, the higher the pressure applied downwardly by pressure roll 86, and the greater the compression of the thermoplastic or thermosetting component of the composite material. In one example, if the measured compressed layer thickness of the last layer or the average of some number of the last several measurements of the layer thicknesses indicates that the layer is too thick relative to a desired value, Δz (the distance by which build platform 52 drops each layer) may be decreased to increase the pressure applied by pressure roller 86 to the next layer to be laminated. Conversely, if the measured layer thickness is too thin relative to the desired (nominal) value, Δz may be increased to decrease the pressure applied by the pressure roller 86.

In another example, if the layer thickness is too thick relative to the nominal thickness, the speed of movement of the pressure roller sub-assembly 71 along the travel (x) axis may be slowed down. The speed of movement of the pressure roller sub-assembly 71 influences the amount of heat that is applied to the lower surface 112b of the current layer 108 (FIG. 2) by changing the exposure time of the laminating material 42 to heat from preheater assembly 105. Slower speeds provide more heat and vice-versa. Slowing down the travel (x) axis speed of pressure roller sub-assembly 71 allows more heat to be absorbed, which in turn causes more melting and flowing of the pre-peg binder, which in turn provides a thinner layer. Conversely, if the layer thickness is too thin, the speed of movement of pressure roller sub-assembly 71 along the travel (x) axis may be increased to reduce the amount of heat absorbed by lower surface 112b of current layer 108.

In yet another example, the heat supplied by preheater assembly 105 may be adjusted to adjust the layer thickness of each layer. As mentioned previously, a non-contact temperature sensor may be used to measure a temperature at a point along the lower surface 112b of current layer 105 (such as at the junction described previously). That temperature may be raised by supplying more current to the infrared preheaters 106a-106c (or to inductive heaters if those are provided instead) and/or by slowing down the speed of movement of the pressure roller sub-assembly 71 along the travel (x) axis. In certain examples, the pressure, speed of travel (x) axis of pressure roller sub-assembly 71 and/or the heat output of preheater assembly 105 are manipulated to control the layer thickness. The temperature of the lower surface 112b is limited by the propensity of the binder to burn and is preferably maintained at a temperature that is lower by some specified amount than one at which burning will occur. In one possible control scheme, the lower surface 112b temperature is maximized to a value that is within a specified tolerance of the binder burn temperature, and the speed of movement of the pressure roller sub-assembly 71 along travel (x) axis is adjusted to achieve the desired layer thickness. In another exemplary control scheme, the lower surface 112b temperature is maintained at a value that is within a specified tolerance from the binder burn temperature, the speed of movement of the pressure roller sub-assembly 71 is set to range between 1 inch/second (2.54 cm/sec) and 6 inches/second (15.24 cm/sec) and is adjusted within those limits to achieve the desired layer thickness. If the pressure roller sub-assembly 71 reaches a high or low travel (x) axis speed limit, the pressure applied by the pressure roller 86 to the composite material is adjusted by adjusting the distance Δz by which the build platform 52 is moved between layers. In general, the pressure roller sub-assembly 71 travel (x) axis speed is from about 1 inch/second (2.54 cm/sec) to about 6 inches/second (15.24 cm/sec), more preferably from about 1 inch/second (2.54 cm/sec) to about 4 inches per second (10.16 cm/sec), and still more preferably from about 1.5 inches/second (3.82 cm/sec) to about 2.5 inches/second (6.35 cm/sec).

Referring again to FIG. 2, in the case of thermoset composite materials, a release liner removal apparatus (not shown) is preferably provided. In one example, the release liner is provided on both the upper and lower surfaces of laminating material 42. As the pressure roller sub-assembly 71 travels along the travel (x) axis (or immediately before it begins to travel in a laminating operation of the type shown in FIG. 2.), the release liner is pulled off of the top and bottom surfaces 112a and 112b.

Thermoset composite materials may be laminated using heat and pressure in the same way described for thermoplastic composite materials. Alternatively, thermoset composites may be laminated using pressure alone, formed into object and waste sections and separated from the spool 42 using cutting apparatus 56 (FIGS. 1A, 1B, 6A, 6B), and then heated at the end of the build by placing the entire object (including waste sections) in an autoclave. The waste sections are then be removed as described previously. As another alternative, pressure and a low level of heat may be applied to the thermoset composite materials during each layer's lamination step to partially cure the thermoset. Cutting assembly 56 then forms the object and waste sections as described previously, and the waste sections are removed. The partially cured object (now without the waste sections) is placed in an autoclave and heated to a curing temperature to complete the curing process.

As mentioned previously, the object data that defines the three-dimensional object being formed on apparatus 40 is preferably converted to layer data that describes he object and waste sections formed on each layer of laminating material 42 and the patterns cut into the waste sections to facilitate their removal from object sections. The sum of the thicknesses of each layer correspond to the build (z) axis height of the three-dimensional object. However, as mentioned above, the actual (compressed) post-lamination layer thickness may deviate from the nominal value provided at the beginning of the object building process and may also vary to some extent during the build. Therefore, in certain examples, the three-dimensional object data is dynamically sliced (also referred to as being sliced “on the fly”) during the object building process. In accordance with one technique, a first portion of the object (along the build (z) axis) is sliced using a first layer thickness (such as the nominal value)). After data is collected (such as using a sliding window technique), an average layer thickness for the first portion of the object is used to slice a second portion of the object based on the as-built height of the first object portion, the expected height of the second object portion, and the average layer thickness calculated for the first object portion. This process may be carried out with varying numbers of object portions of varying heights. Using more object portions requires more computational to carry out multiple data slicing operations but yields more accurate parts.

### Example 1

### Dynamic Data Slicing

An object having a build (z) axis height of 10 cm is defined by three-dimensional object data, such as STL data. The predicted (compressed, post-lamination) layer thickness is 100 microns (100×10⁻⁶ m). To illustrate the technique, a simple case involving only two dynamic slicing operations is used. However, any number of dynamic slicing operations may be used. A first portion of the object height comprising fifty (50) percent of the height (5 cm) is sliced using the 100 micron predicted layer thickness, yielding 500 layers. The layer thickness Δz is controlled using the techniques described previously (manipulating the speed of the pressure roller sub-assembly 71 along the travel (x) axis, manipulating the heat output from the preheater assembly 105, and/or adjusting the movement of the build platform after each layer Δz to increase the pressure applied by pressure roller 86). At the end of the 500 layers, the actual object height is 4.5 cm, and the sliding average layer thickness is 95 microns. The remaining object height to be built is 5.5 cm. Using the current sliding average layer thickness, the number of slices in the second object section is 0.055/(95×10⁻⁶)=579 layers. The remaining 5.5 cm of the object is sliced into 579 layers, each having a predicted layer thickness of 95 microns. The predicted layer thickness of 95 microns is used as the desired (set point) of the layer thickness controller (which may be an algorithm embodied in software as opposed to a specific hardware controller), and the layer thickness manipulated variables described above are manipulated (alone or in any combination) to achieve it.

In preferred examples of the present disclosure, a cutting assembly 56 (FIGS. 6A and 6B) is used to carry out the forming operation. The cutting assembly 56 cuts a pattern into the current layer 108 of laminating material 42 in accordance with the contours of the object being built, thereby creating an object section (section defining that part of the layer which will comprise part of the finished object) and a waste section (the portions of the layer other than the object section). The object section data may be vector data defining the contours of the object section. The cutting assembly 56 also cuts a pattern into waste sections (portions of current layer 108 that will not comprise part of the finished object) which facilitate the separation of the waste sections from the object section. In addition, cutting assembly 56 is used to sever the laminated layer from the roll of laminating material on spool 46.

Referring to FIGS. 1A and 1B and 6A and 6B, laminating material forming assembly 53 includes a cutter translation assembly 54. Cutter translation assembly 54 comprises a horizontal (in the x-y plane) frame 68 defined by frame members 72a-72d (FIG. 1B). A cutter translation assembly 54 also comprises a translation frame 77 defined by side members 84a and 84b which are oriented vertically and spaced apart from one another along the y-axis and by cross-member 76 which joins side members 84a and 84b. The inward facing surfaces (along the y-axis) of side members 84a and 84b include suitable bearings to slidingly engage rails 74a and 74b (FIGS. 1A and 1B) formed on the side of side frame members 72a and 72b, respectively.

A y-axis translation support 78 is movable along the cross-member 76 along the y-axis and is attached to mount plate 82. Ultrasonic cutter 137 (FIG. 6A) controls the reciprocation of blade 140 along the build (z) axis at ultrasonic frequencies. Ultrasonic cutter 137 is attached to a cutter rotation assembly 142 which his mounted on a horizontal base plate 135. The cutter rotation assembly 142 rotates blade 140 about the longitudinal axis of blade 140 which is parallel to the build (z) axis and which allows the blade 140 to trace curved paths as the translation frame 77 moves along the travel (x) axis and as the y-axis translation support 78 moves along the y-axis (while riding on the horizontal cross-member 76). Thus, blade 140 has four degrees of freedom (rotation (w), x-axis translation, z-axis and y-axis translation) in addition to reciprocating along the build (z) axis.

The horizontal base plate 135 is attached to mounting plate 82 via bracket 141. Blade 140 projects downward along the build (z) axis beneath the horizontal base plate 135. A closed loop stepper motor 147 controls the rotation of blade 140 about its longitudinal axis. Timing belt pulleys 149a and 149b have a timing belt 144 mounted thereon such that rotation of motor shaft 151 rotates pulley 149a, causing the timing belt 144 to move and adjust the rotational position of ultrasonic cutter 137, blade housing 153, and blade 140 about the longitudinal axis of blade 140 and the ultrasonic cutter 137, which axis is parallel to the build (z) axis. Bearings 155 are disposed between an inner bearing shaft 156 and an outer bearing shaft 158 and support blade housing 153 while allowing it to rotate. Upper bearing retainers 152 and 154 and lower outer bearing retainer 160 retain the bearings 155, the inner bearing shaft 156, and the outer bearing shaft 158.

Thus, during an object section cutting operation, the cutter translation assembly 54 travels along the travel (x) axis as the y-axis translation support 78 travels along the y-axis while blade 140 reciprocates at ultrasonic frequencies along the build (z) axis and rotates about its longitudinal axis. The extent of blade 140 travel along the build (z) axis as it reciprocates is preferably such that the blade performs a “kiss cut” and only cuts the current layer without cutting the layer immediately beneath it. In certain preferred examples, various blades can be selectively attached to the blade housing 153. The blades may vary in overall length and in their profile, i.e., the variation in their width as a function as position along their length. As one example, a v-shaped blade may be used which narrows in width to a point as you move along the build (z) axis toward the build platform. Different blade lengths and different blade profiles may be tailored to the thickness or other properties of the laminating material 42. Suitable motors are provided to translate the cutting assembly 56 along the travel (x) axis and the y-axis translation support 78 along the y-axis. In preferred examples, the motors are connected to a controller that operates in response to data representative of the three-dimensional object (such as vector data or G-Code data defining the contours of the each layer's object section (s)) being built so that that the object section defined by the blade 140 corresponds to the object. In addition to defining object section 252, cutting assembly 56 cuts the travel (x) axis border 257 (FIG. 1E) of the laminating material 42 to separate it from the spool 46 so that another layer may be created.

In certain examples, apparatus 40 includes a blade changing assembly (not shown). The blade changing assembly is similar to known CNC tool changers and provides a mechanism for automatically changing blade 140 by moving the cutting assembly 56 to a location where new blades are available and causing the cutting assembly to dispense the existing blade 140 and pick up a new one. The blade changing assembly allows the apparatus 40 to use varying blades of varying width profiles during a single object building operation if so desired. In preferred examples, the controller that manipulates cutting assembly 56 includes a program that positions the tips of new blades to a reference position along the build(z) axis and also positions the blade in a reference rotational orientation about the longitudinal axis of the blade, and in some cases, at a reference x, y position. From the reference position and orientation (xᵣ, yᵣ, zᵣ, wᵣ), the blade can be moved to the x, y location where cutting is desired and placed in the proper rotational orientation and at the proper build (z) axis height. In preferred examples, a button or other contact mechanism of fixed height relative to a portion of apparatus 40 that is fixed along the build (z) axis is used to align a new blade's tip along the build (z) axis. In one case, a button is placed outside the build envelope, and the tip of blade 140 is moved downward until contact is detected, at which point the tip of the blade 140 is at the reference build (z) axis position. As the button has a fixed x, y position, such contact fixes the location of the tip in all three coordinates: x, y, and z. Another sensor may be provided which detects the rotational orientation w of the blade 140 so that the blade can be rotated to a reference rotational orientation about its longitudinal axis. By using the rotational sensor and the button, a reference condition for all four degrees of freedom is defined and can then be related to a desired rotational orientation, blade position in the build envelope, and build (z) axis height so that the blade may be moved and rotated appropriately to arrive at a desired cutting location in the build envelope in the correct rotational orientation, the correct x, y, and z locations. In other words, every x, y, and z position and rotational orientation used to create an object section or to cut a waste section may be related to the reference condition xᵣ, yᵣ, zᵣ, wᵣ.

In certain preferred examples, ultrasonic cutter 137 includes a sensor that measures the actual frequency of reciprocation of blade 140 along the build (z) axis. A comparator circuit (which may be in software) compares the measured frequency of reciprocation and compares it to a nominal frequency or setpoint. The comparator signal is then output to a suitable controller and display unit. If the difference between the measured frequency and the nominal frequency is greater than a specified threshold, then the blade is presumed broken, and the controller manipulates the cutting assembly 56 to pick up another blade and discard the current blade.

Over time, particular blades 140 my wear out and become unsuitable for further use. In certain examples, an algorithm determines the amount of wear a blade 140 has endured based on a number of variables, including at least one of the number of hours of operation, the total lineal feet of cutting, and a materials parameter indicative of the difficulty of cutting the laminating material 42. A controller may be provided which comprises a processor and a non-transitory computer readable medium with computer executable instructions stored on it which, when executed by the processor, determine a level of blade wear. When the level of blade wear exceeds a certain threshold, the controller causes the cutting assembly to pick up another blade and discard the current blade.

An example of an object section is shown in FIG. 1C. A layer 251 of laminating material 42 is disposed on build platform 52. The layer 251 comprises object section 252 and waste section 253. An interface 255 defines the border between the object section 252 and the waste section 253. The interface 255 is defined by a vector data in the x, y plane within the build envelope. Following the lamination of all the object layers, the waste section 253 from object section 252 and the waste sections of the other layers will be removed to leave behind the finished object. In certain preferred examples, the resting (non-reciprocating) position of the blade 140 along the build (z) axis is adjustable so that blades with a varying profile along their lengths (e.g., v-shaped blades) can make deeper or shallower cuts in the current layer as desired. For example, it may be desirable to make a deeper cut with a v-shaped blade so that the cut is wider when cutting interface 255 between object section 252 and waste section 253 and to use a shallower cut when forming the waste section 253 into removable shapes (e.g., cubes). The wider cut at the object section/waste section interface better ensures that the object section will not be damaged when separating the waste section from it.

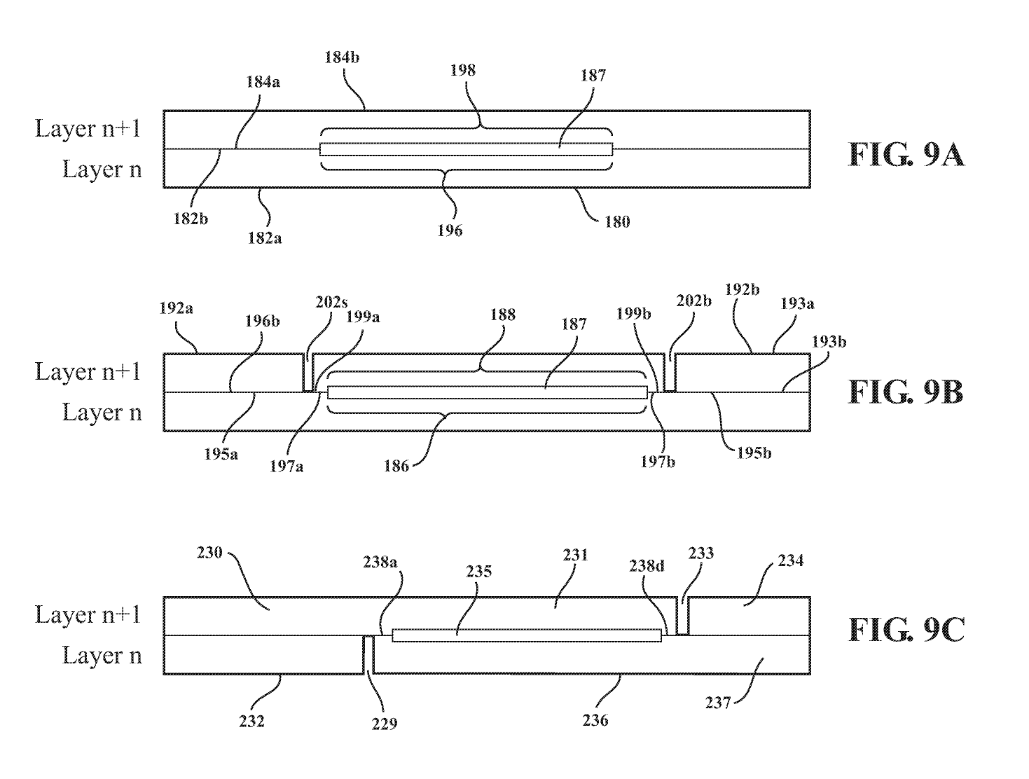

In certain preferred examples, an adhesion reducing material is applied along the interface 255 to better enable the removal of waste section 253 from object section 252 without damaging object section 252. The adhesion reducing material is preferably one that is selected based on the binder (polymeric matrix) of laminating material 42 to disrupt adhesion between object section 252 and waste section 253 such that following lamination, regions with the adhesion reducing material will not adhere or bond together. In one example, silicone oil is used as the adhesion reducing material. Other suitable adhesion reducing materials include natural or synthetic paraffin waxes. As discussed further below with respect to FIGS. 9A-9C, when the adhesion reducing material is deposited on a layer of laminating material 42 at a desired location within the build envelope, and the adhesive (polymer matrix) of the laminating material 42 is at or above the lamination temperature, an adjacent layer does not adhere to the layer at the desired location. Both water-based and solvent-based adhesion reducing materials may be used.

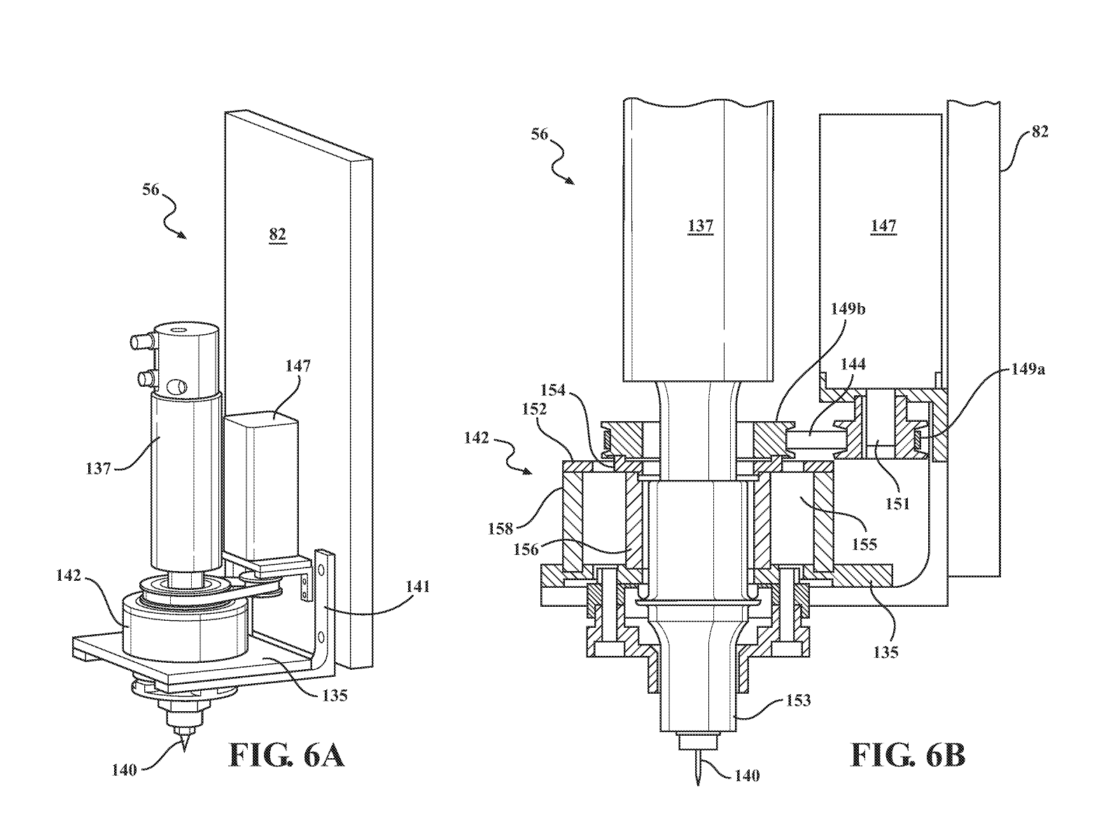

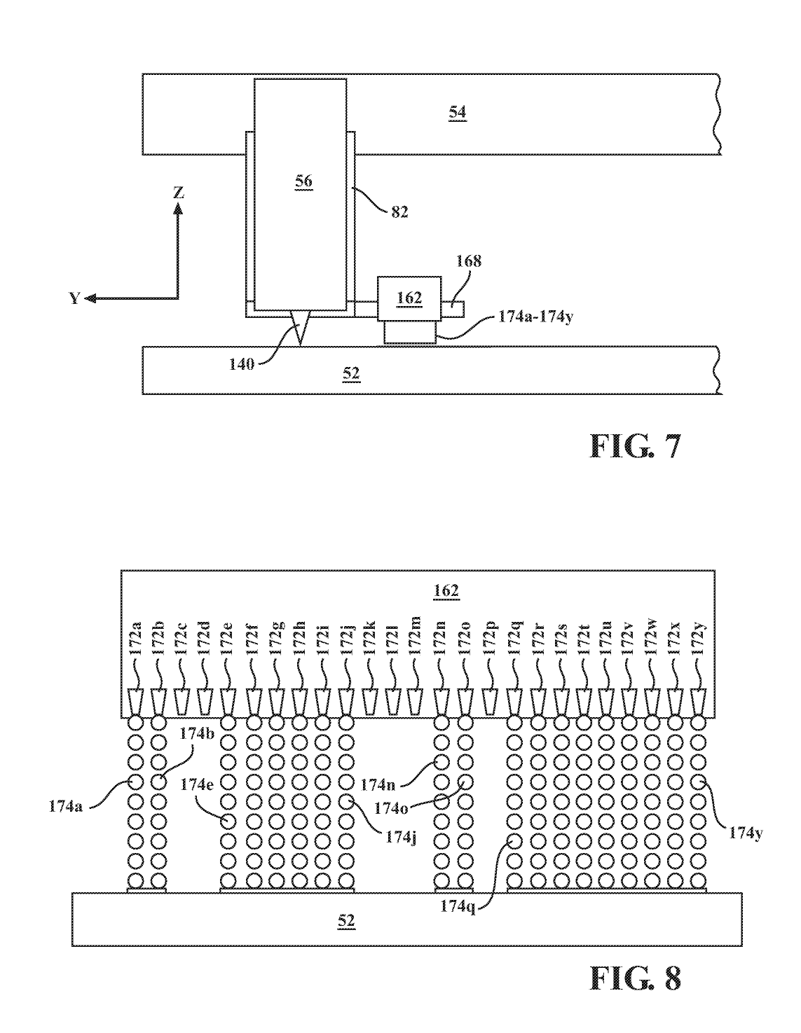

In certain preferred examples, a printhead movable along the travel (x) and y axes is used to apply the adhesion reducing material to interface 255. When a printhead is used, the adhesion reducing material preferably has a viscosity that makes it jettable. The printhead also preferably includes an internal heater for controlling the viscosity of the adhesion reducing material. An exemplary printhead 162 is shown in FIGS. 7 and 8. As best seen in FIG. 8, printhead 162 has a plurality of openings 172a-172y which are arranged along a print axis parallel to the y-axis. The openings 172a-172y are in selective fluid communication with a source of the adhesion reducing material (not shown in the figure but self-contained in the printhead 162). Each opening 172a-172y may selectively dispense the adhesion reducing material at a particular x, y location in the build envelope as dictated by the interface 255 pattern. For example, in FIG. 8 streams 174a, 174b, 174e-174j, 1741-174m, and 174q-174y are dispensed from their corresponding openings 172a, 172b, 172e-172i, 1721-172m, and 172q-172y. The remaining openings are not in fluid communication with the source of adhesion reducing material and are not dispensing streams of the fluid. In certain examples, printhead 162 provides a printing width of 100-400 dots per inch. Suitable commercially available printheads 162 include Xaar Multijet Printheads and the Q-class or StarFire™ SG1024 printheads supplied by Fujifilm Dimatix, Inc. Printhead 162 may be provided with its own x-y gantry assembly. However, in one preferred example, printhead 162 is attached to cutting assembly 56, as depicted in FIG. 7. For ease of viewing the layers of composite material are not shown in FIG. 7. Printhead 162 is in a fixed spatial relationship relative to cutting assembly 56 and blade 140, as well as to mounting plate 82 which attaches the cutting assembly 56 to y-axis translation support 78 (not shown in FIG. 7). In FIG. 7, the printhead 162 is spaced apart from cutting assembly 56 along the y-axis and moves along both the x and y axes in coordination with cutting assembly 56. Bracket 168 connects printhead 162 to mounting plate 82 to maintain the fixed spatial relationship between the printhead 162 and the cutting assembly 56. Thus, as blade 140 cuts one portion of the interface 255 that defines object section 252 and waste section 253, printhead 162 simultaneously dispenses adhesion reducing material along another (previously cut) portion of the interface 255 to disrupt the adhesion between the binder (polymeric matrix) in the bordering portions of object section 252 and waste section 253. In preferred examples, the controller that controls the movement of the blade 140 includes a processor and a non-transitory computer readable medium with instructions stored thereon, which when executed by the processor, translate the blade movement vector data into data dictating which openings 172a-172y will dispense adhesion reducing fluid at a given x, y position of the blade based on the fixed spatial relationship between the printhead 162 and the blade 140.

In certain examples, a controller is provided which comprises a processor and a non-transitory computer readable medium having instructions stored thereon, and when executed by a processor, the instructions cause printhead 162 to selectively open the printhead openings 172a-172v to dispense the adhesion reducing material. The pattern of the deposition is dictated by object data that defines the geometry of interface 255 as adjusted for the offset between the printhead 162 and the blade 140.

The cutter translation assembly 53 and y-axis translation support 78 respectively move the cutting assembly 56 in the x and y directions. With many three-dimensional objects, object sections will have curved object contours, and a technique is required to convert the discrete orthogonal movements of the cutter translation assembly 53 and the y-axis translation support 78 into curved paths. In one example, linear interpolation is used. With linear interpolation, a curved path is translated into a series of short linear paths. As the distance of each movement approaches zero, the path approaches a true curve.

In another example, circular interpolation is used in which the curved path is translated into a series of second degree polynomials. However, circular interpolation is limited to second degree curves. Thus, in a preferred example, curved paths are defined using spline interpolation, which allows for higher order interpolation. For example, cubic or higher order splines will more closely approximate cutting paths having an inflection point (where the second derivative y″(x) is zero) because the splines will themselves have an inflection point. In preferred examples herein, the object contours in each layer are approximated using splines that define the entire object contour as a single curve. Preferably, the speed of movement of the cutting assembly 56 is varied and optimized based on the degree of curvature at a given location, with the speed increasing at relatively straighter (high radius of curvature) regions than at relatively curved (low radius of curvature) regions.

Referring to FIGS. 1A and 1B, build platform 52 is a surface upon which the laminated object is progressively built. During an object building operation, build platform 52 descends along the build (z) axis as the object is progressively built upward along the build (z) axis. In certain preferred examples, build platform 52 is rotatable in the x-y plane. Build platform 52 sits on and is secured to vacuum plate 58. Build platform 52 has a plurality of openings in fluid communication with vacuum plate 58 which provides a source of subatmospheric pressure to the bottom layer of the three-dimensional object being built, causing the object to be removably secured to build platform 52 until the source of the vacuum is adjusted or shut off. Adapter 60 connects rotary table 98 to vacuum plate 58. Rotary motor 96 adjusts the rotational position of adapter 60, vacuum plate 58, and build platform 52.

Table lift 50 provides a frame for mounting build platform 52 and allowing it to translate along the build (z) axis and rotate in the x-y plane. Rotary table 98 is mounted on threaded shafts 94a and 94b which engage corresponding threaded portions of rotary table 98. Rotary table 98 includes a rotating carriage 62 which is rotatable in the x-y plane relative to table lift 50 and the remainder of rotary table 98. Rotation of shafts 94a and 94b causes build platform 52, vacuum plate 58, and rotary table 98 to translate along the build (z) axis. A motor (not visible) rotates horizontal shafts 91a and 91b (not shown). Suitable gears translate the rotation of horizontal shafts 91a and 91b into the rotation of vertical shafts 94a and 94b to adjust the build (z) axis position of build platform 52. Rotary table 98 also includes linear bearings (not shown) which engage rails 95a, 95b (not shown), 97a, and 97b (not shown). Rails 95a and 97a are mounted on mounting plate 99a, and rails 95b and 97b are mounted on mounting plate 99b.

Rails 95a and 95b are spaced apart along the travel (x) axis and positioned at the same location along the y-axis. Rails 97a and 97b are spaced apart along the travel (x) axis and positioned at the same location along the y-axis. Rails 95a and 97a are spaced apart along the y-axis at the same travel (x) axis position. Rails 95b and 97b are spaced apart along the y-axis at the same travel (x) axis position.

FIGS. 1C-1E schematically illustrate the use of the rotating build platform 52 to provide layers of laminating material 42 with varying fiber length orientations. In general, the rotation of build platform 52 is useful for any anisotropic fiber composite materials because the degree of rotation of adjacent layers may be adjusted so that the directional component of their mechanical properties is not parallel. However, the degree of rotation for adjacent layers is preferably less than the angle between the different groups of fibers. For example, if a composite material has continuous fibers oriented orthogonally to one another, and the mechanical properties of each layer are the same along each orthogonal axis, the build platform 52 will be rotated less than ninety degrees between adjacent layers. Otherwise, the rotated layer will have the same fiber orientation as the unrotated layer (the fibers will be parallel), obviating any benefits from rotation. If fibers are oriented at 45 degrees relative to one another, the angle of rotation between adjacent layers will preferably be less than 45 degrees. In the example, laminating material 42 is a pre-peg with anisotropic fibers oriented parallel to one another throughout the entirety of the laminating material roll on spool 46. FIG. 1C depicts a layer 251 following the completion of a cutting operation that defines object section 252 and waste section 253 and a cutting operation that separates the layer 251 from the laminating material spool 46. The layer 251 is adhered to a previous layer (not visible) and the stack of layers is disposed on build platform 52. Axis 254 is parallel to the lengths of the fibers in laminating material 42. Build platform 52 is then rotated in a counterclockwise direction in the x-y plane. The angle of rotation is less than 90°, preferably from 20°-60°, more preferably from about 30°-50°, and still more preferably about 45° C. The material advancement assemblies 124a and 124b grip the free end 261 (FIG. 1E) of the composite material 242 and pull it in a direction along the travel (x) axis away from spool. 46. This “current” layer 250 is then laminated to the previous layer 251 as described previously. Because lamination occurs before cutting, no registration step is necessary to align the layers.

Cutting assembly 56 forms the object section for current layer 250 and the waste section for current layer 250. As can be seen by comparing FIGS. 1D and 1E, the fiber length axis 254 in FIG. 1D is not parallel to the fiber length axis 254 in FIGS. 1E and is oriented differently relative to the free edge 261 of the composite material and relative to build platform 52 in FIGS. 1D and 1E. The process of rotating and laminating layers may continue for the entire object build and provides a finished object that is significantly stronger than one in which the fiber axes 254 of all layers are parallel. In certain examples, the object data (e.g., vector data) defining the object section is defined based on one specific rotational orientation of build platform 52 and a controller is provided which comprises a processor and a computer readable medium with instructions stored thereon which, when executed by the processor, translate the object data to account for the rotation of the build platform 52 in the x-y plane.

As mentioned previously, the material advancement assemblies 124a and 124b have grippers 146a and 146b which can grip a free edge of laminating material 42 on spool 46. The grippers 146a and 146b preferably pull the free edge either to the edge of the build envelope or to the farthest position along the travel (x) axis at which the object will be present for the current layer. Note that the x and y axes remain fixed when the build platform 52 rotates and are defined by the direction of travel of the pressure roll 89 and the cutter translation assembly 54. However, the object data may be defined in a Cartesian coordinate system that is based on the build platform 52, thus requiring translation when the platform 52 rotates in the x, y plane.

In order for the grippers 146a and 146b to pull the free edge of the laminating material 42, they have to pass the pressure roller 89 and guide roller 102 of the laminating assembly 70. When the pressure roller 89 and guide roller 102 are in the orientation of FIG. 2, the grippers 146a and 146b cannot pass them. Therefore, in certain preferred examples, the pressure roller subassembly 71 is pivotable relative to the x-y plane so that pressure roller 89 is spaced apart above grippers 146a and 146b in the build (z) axis direction and guide roller 102 is spaced apart below gripper 146 along the build (z) axis. FIG. 5 illustrates the pressure roller subassembly 71 in a pivoted (non-laminating) orientation. In the pivoted orientation, gripper 146 can pass between brackets 100a and 100b underneath pressure roller 86. As illustrated in FIG. 5, gripper 146a has just gripped a free edge 261 of laminating material 42 and is about to pull it to the right as indicated by the right-facing arrow. The pressure roller sub-assembly 71 has pivoted clockwise from its laminating orientation so that the pressure roller 89 is spaced apart from the gripper 146a in the positive build (z) axis direction, and the guide roller 102 is spaced apart from the gripper 146a in the negative build (z) axis direction. Note that the material advancement assembly motor 126a, the pinion gear 150a and the rack gear (not shown) are outboard of the cutting assembly frame 68 and the laminating assembly horizontal frame 73. The same holds for the material advancement assembly 124b and its corresponding components.

In certain examples, an adhesion reducing material of the type described previously is used to prevent adhesion between object sections and waste sections in immediately adjacent layers of laminating material 42. Referring to FIG. 9A, layer n is first laminated to a previous layer (not shown) and cut by cutting assembly 56 to define a waste section 180 comprising a downward (along the build (z) axis) facing surface 182a and an upward (along the build (z) axis) facing surface 182b. Before depositing and laminating next layer n+1, adhesion reducing material 187 is applied to a desired location 186 on the upward facing surface 182b of waste section 180 of layer n. The adhesion material may be applied in a continuous pattern or a discontinuous pattern or a partially continuous pattern (e.g., a mesh pattern). The downward facing surface 184a of layer n+1 is heated using preheat heater assembly 105 and pressure roller 86 rolls and applies downward (along the build (z) axis) pressure to the upward facing surface 184b of layer n+1. At this point, layer n+1 is an integral sheet of laminating material 42. The previously applied adhesion reducing material 187 contacts a central portion 188 of what will become an object section 194 (FIG. 9B) of layer n+1. An object forming operation is then commenced and cutting assembly 56 makes kiss cuts 202a and 202b in layer n+1 to define two waste sections 192a and 192b and object section 194. Downward facing surface 196b of waste section 192a is in abutting contact with an upward facing surface of outside region 195a of layer n and downward facing surface 193b of waste section 192b of layer n+1 is in abutting contact with an upward facing surface of outside region 195b of layer n. In FIGS. 9A and 9B the entire depicted portion of layer n is a waste region. Although not shown, the entire depicted section of layer n will be cut by cutting assembly 56 (e.g., by cubing) to facilitate removal of the depicted section from the finished object. Similarly, outward waste regions 192a and 192b of layer n+1 will be cut by cutting assembly 56 to facilitate removal from the finished object. In addition, adhesion reducing material 187 is preferably deposited in the interfaces defined by kiss cuts 202a and 202b, such as by using a printhead 162 in the manner described previously.

Section 194 of layer n+1 is an object section. Adhesion reducing material 187 does not cover the entire downward facing surface of object section 194. Instead, two small edge portions or “spot welds” 199a and 199b are maintained. However, when the lamination steps are complete the entirety of layer n will be separated from the finished object, leaving behind the entirety of object section 194, including the edge portions 199a and 199b, as part of the finished object. By maintaining adhesion between layers n and n+1 at edge portions 199a and 199b, the waste sections and object sections remain an integral whole until the lamination of all object layers is complete. The waste sections thus act as supports for downward facing surfaces of the object and remain in place until all of the object sections have been formed.

FIG. 9C shows an example where an adhesion reducing material 235 is used in an intermediate overhang section 231 of an upper layer n+1. Layer n is first deposited on and laminated to a previous layer (not shown). Section 232 of layer n is an object section and section 236 is a waste section. The cutting assembly 56 makes a kiss cut 229 in layer n to define object section 232 and waste section 236. Waste section 236 will be cubed or otherwise cut appropriately by cutting assembly 56 to facilitate its removal from the finished object. Although not shown, adhesion reducing material 235 is preferably deposited within the kiss cut 229 to prevent object section 232 from adhering to waste section 236. Adhesion reducing material 235 is deposited on the area of an upward facing surface of waste section 236 which corresponds to a central region of the overhang section 231 of the object section 230 of layer n+1.

Layer n+1 is then deposited on and laminated to layer n using the pressure roller sub-assembly 71 as described previously. Kiss cut 233 is made in layer n+1 to define object section 230 and waste section 234. Waste section 234 is cubed or otherwise cut appropriately by cutting assembly 56 to facilitate its removal from the finished object. Adhesion reducing material is preferably deposited in the object section/waste section interface defined by kiss cut 233 in the manner described previously.

Object section 230 includes an overhang 231 which is defined between kiss cut 229 in layer n and kiss cut 233 in layer n+1. Overhang 231 is a region that will be unsupported once the object is finished and waste section 236 of layer n is removed. Thus, a first portion of waste section 236 lies underneath and support overhang 231 of layer n+1 and another portion 237 of waste section 236 lies underneath waste section 234 of layer n+1. The adhesion reducing material 235 is applied only in a central region of overhang 231 leaving edge portions (or spot welds) 238a and 238b bound to waste section 236 of layer n. As with edge portions 199a and 199b in FIG. 9B, edge portions 238a and 238b maintain the integrity of the combined object and waste sections so that the waste sections do not separate from the object sections until desired. However, the separation is made easier by the use of adhesion reducing material 235 than would otherwise be the case.

One advantage of using the apparatuses and methods described herein as opposed to stereolithography or other photopolymer-liquid hardening 3D printing methods is that “nested” parts may more easily be produced. “Nested” parts are parts having the same relative geometry but different overall dimensions so that one part may fit inside the open space of another part, like a stack of successively smaller bowls stacked one inside the other. With techniques that harden a photopolymer, removable supports must be created between each successive object to keep them spaced apart. The creation of removable supports from the photopolymer adds additional processing time. With the techniques described herein, laminating materials 42 that would ordinarily become waste sections may be formed into a nested object and easily separated at the end of the build process (because the waste sections are formed into readily removable shapes like cubes). In LOM processes such as those described herein, minimization of waste sections is desirable because the waste sections cannot be reused to form three-dimensional objects and are discarded. In the case of a single bowl formed with LOM, the entire interior of the bowl would comprise waste. Thus, any additional nested bowls that can be made will necessarily reduce the amount of waste. This waste concern does not apply in photopolymer based systems because any material that is not used to form the three-dimensional object during a given object build process remains available to build subsequent objects and is not wasted. Thus, not only is nesting more important in LOM processes of the type described herein than in photopolymer based processes, but it can be done more quickly and efficiently because waste sections which act as supports between the nested objects in the methods of the present disclosure do not need to be solidified as is the case with photopolymer object supports.

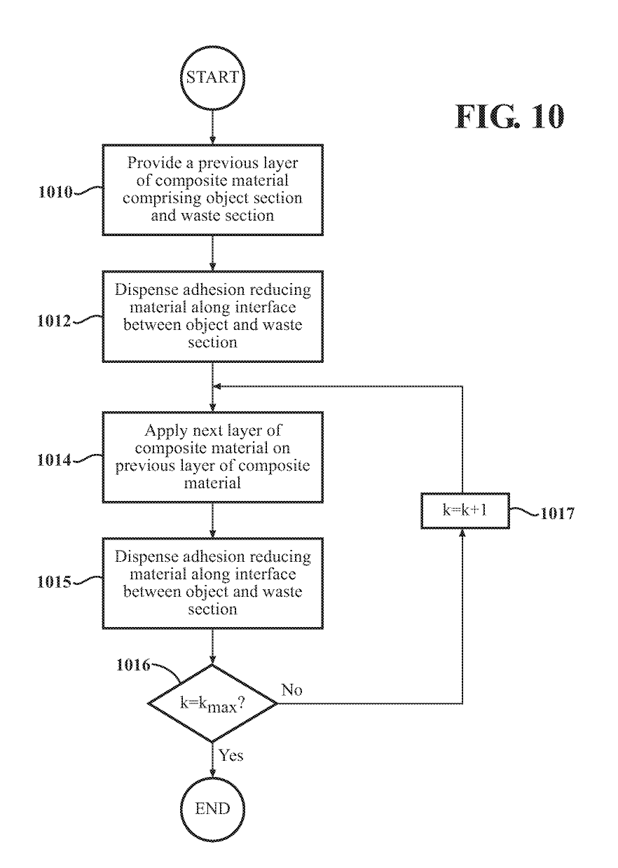

Methods of making three-dimensional objects by laminating composite materials will now be described. Although not shown in the methods of FIGS. 10-12, in each case the build (z) axis position of a build platform is preferably adjusted following the lamination of one layer and prior to the lamination of another layer. The distance Δz by which the build platform is moved may be based on a nominal value stored in a job file prior to the object building process and/or may be based on measured or statistically averaged measurements of the compressed, laminated layer thicknesses as described previously. The composite materials may comprise reinforced plastics and in some cases comprise pre-pegs having fibers embedded in a polymeric matrix of a thermoplastic or thermosetting binder. Referring to FIG. 10, in step 1010 a previous layer of composite material is provided which comprises an object section and a waste section. The object section and waste section are defined by a forming operation, such as one carried out using cutting assembly 56 in the manner previously described. The previous layer is laminated on an earlier layer or to a build platform such as build platform 52. The object section and the waste section have an interface that divides the layer of laminating material 42 into the two sections. The waste section is cut into cubes or other shapes that facilitate separation from the object when it is completed.

In step 1012 an adhesion reducing material is dispensed along the interface(s) between the object section and the waste section. In addition, if portions of the previous layer comprise an object section or waste section which will abut the other of an object section or a waste section in the next layer, all or some of those portions of the previous layer may have the adhesion reducing material applied to them. As explained previously, in certain examples, it is desirable to leave edge portions (spot welds) of abutting object and waste sections in adjacent layers untreated with an adhesion reducing material so that the waste sections provide object support until the object is complete and ready for removal.

In step 1014 a next layer of laminating material 42 is laminated onto previous layer of laminating material 42. In preferred examples, the surface of the current layer of laminating material 42 which faces a surface of the previous layer of laminating material 42 is heated (such as by using preheater assembly 105) to cause the binder (polymeric matrix) component of the current layer to adhere to the binder of the previous layer as pressure roller 86 rolls and translates on the upward (along the build (z) axis) facing surface of the current layer of laminating material 42. The current layer is then subjected to a forming operation (such as by using cutting assembly 56) to create an object section and a waste section in the current layer. The forming operation is carried out in accordance with data representative of the three-dimensional object. The waste section is cut in a pattern (e.g., cubes) that facilitates its removal from the finished object.

In step 1015 the adhesion reducing material is applied to the interface(s) between the object section and the waste section. In step 1016, a determination is made as to whether the last layer of the object has been completed by comparing the current layer index k to the maximum layer index kₘₐₓ. If the last layer has been completed, the process ends. Otherwise, control transfers to step 1017 where the layer index k is incremented.

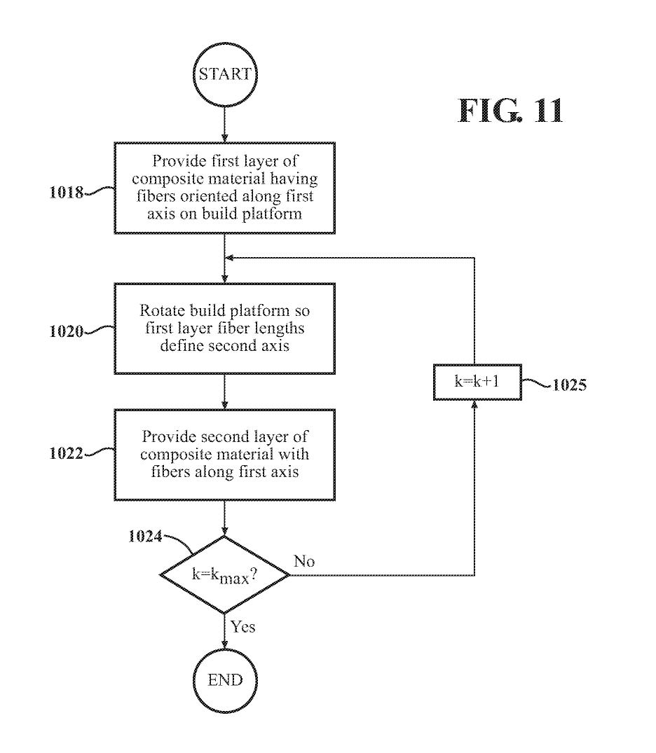

Another method of making a three-dimensional object in accordance with the present disclosure is described in FIG. 11. In step 1018 a first layer of laminating material 42 is provided and is laminated to an earlier layer of laminating material 42 or a build platform such as build platform 52. The first layer comprises fibers in a polymeric matrix wherein the fibers are oriented in the same direction and have lengths oriented along a first axis 254. However, the technique can be used with bidirectional and multidirectional fiber anisotropic reinforced fiber plastics also. An exemplary illustration is provided in FIG. 1C in which previous layer 251 is adhered to an earlier layer which is adhered (directly) or via other layers to build platform 52. Following a forming operation, object section 252 and waste section 253 are defined as is interface 255. Adhesion reducing material is preferably applied to interface 255 as described previously.

In step 1020 the build platform 52 is rotated (counterclockwise in the example of FIGS. 1C-1E) so that the lengths of fibers in layer 251 are oriented such that first axis 254 is rotated relative to its position in FIG. 1C. In the example of FIGS. 1A and 1B, the build platform 52 is rotated by activating motor 96. The build platform is rotated by an amount that is preferably at least about twenty degrees, more preferably at least about thirty degrees, and still more preferably at least about forty degrees. The build platform is rotated by an amount that is preferably no more than about eighty degrees, still more preferably no more than about sixty degrees and even more preferably no more than about fifty degrees.

In step 1022 a second layer of composite material is provided with its fiber length axis 254 oriented along the same axis (the travel (x) axis) as shown in FIG. 1C. In certain examples of step 1022, free edge 261 (FIG. 1E) of laminating material 42 is advanced along the travel (x) axis to the edge of the build envelope to define layer 250. Layer 250 is then laminated to layer 251 as described previously. In FIG. 1C fiber length axis 254 is angled relative to its orientation in FIG. 1D. An object forming operation is carried out to define an object section, a waste section, and an interface between the object section and the waste section. The waste section is cubed or otherwise cut to facilitate its removal from the finished object. Layer 250 is cut at edge 257 by cutting assembly 56 to separate the layer 250 from the composite material spool 46. In step 1024 a determination is made as to whether the last layer has been reached by comparing the current layer index k to the maximum layer index kₘₐₓ. If the last layer has been reached, the process ends. Otherwise, control transfers to step 1025 and the layer index is incremented.

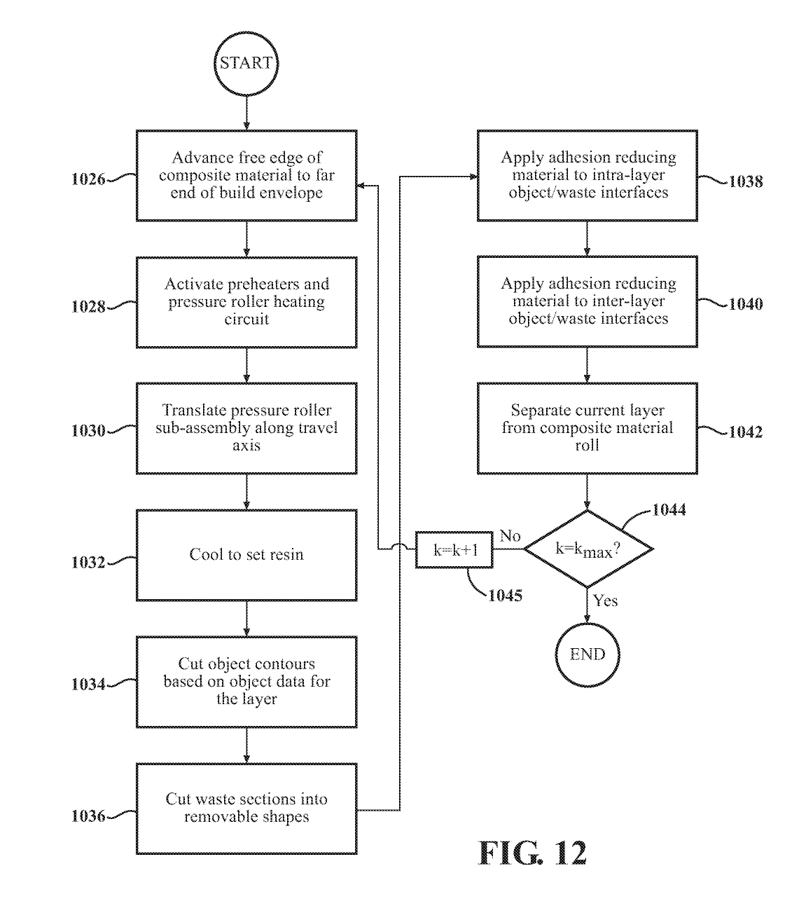

Referring to FIG. 12, another method of making a laminated three-dimensional object from composite materials is described. The composite materials are preferably reinforced fiber plastics and in certain examples are pre-pegs comprising a thermoplastic or thermoset binder pre-impregnated in fibers. In accordance with the method, a spool of composite material (such as spool 46 of laminating material 42) is provided. A free edge of the composite material is advanced to the edge of the build envelope on build platform 52 (step 1026). In step 1028, the preheaters (such as preheaters 106a-106c in pressure roller sub-assembly 71) are activated as is the heating circuit in pressure roller 86. The temperature of the preheaters 106a-106c is selected to heat the polymeric matrix in the composite material to a lamination temperature (which is above the glass transition temperature T_{g}). The lamination temperature is selected based on the material to provide a desired degree of binder melting and flow, and is typically provided as a default value in a job file which may subsequently be adjusted during the object build to control the layer thickness as discussed further below.

The temperature of the pressure roller 86 surface is selected to be below the glass transition temperature T_{g} of the polymeric matrix component of the laminating material 42. In one example using PEEK carbon fiber fabric as laminating material 42, the junction temperature where lower surface 112b of current layer 108 meets upper surface of 114b of previous layer 110 is 735±15° F. (390±8.3° C.), and the pressure roller surface temperature is less r than the glass transition temperature 289° F. (143° C.). The pressure roller sub-assembly 71 is then translated along the x-axis with the guide roller leading the pressure roller as depicted in FIG. 2 (step 1030). The just applied layer is then cooled to allow the heated polymeric matrix in the reinforced fiber plastic to set (step 1032).

In step 1034 a forming operation is carried out, such by using cutting assembly 56. The forming operation creates object contours that define an object section and a waste section on the layer which abut each other along an interface. The contours are defined by vector data. When cutting assembly 56 is used for the forming operation, the interface is where the cutting occurs. The waste section is then cut into removable shapes, such as cubes, to facilitate its eventual removal from the finished object.

In step 1036 an adhesion reducing material of the type described previously is applied to the intra-layer object section/waste section interface(s). In preferred examples, the adhesion reducing material is also applied to inter-layer object section/waste section interfaces, i.e., regions of waste sections which will abut object sections in the next layer and/or regions of object sections that will abut waste sections in the next layer (step 1040). In certain preferred examples, adhesion reducing material is not applied at the edges of such abutting regions, thereby creating spot welds that maintain the stability of the waste sections and object sections as the object is being built so that the waste regions do not prematurely separate from abutting object sections in an adjacent layer before all layers are laminated.

In step 1042 the current layer is separated from the composite material spool 46 such as by using cutting assembly 56. A determination is made as to whether the current layer is the last layer by comparing the value of the current layer index k to the value of the maximum layer index kₘₐₓ. If the current layer index value equals the maximum layer index value, the process ends. Otherwise, control transfers to step 1045 and the layer index is incremented by one. In some examples wherein reinforced fiber plastics or pre-pegs with parallel fibers in each sheet are used as the laminating material 42, before step 1026 is repeated, the build platform may be rotated (depending on the strength requirements of the object being built) as described previously with respect to FIG. 1E so that alternating layers have their fiber length axes oriented at different angles with respect to one another. In other examples, steps 1038 and 1040 involve the use of a printhead such as printhead 162 to dispense the adhesion reducing material.

In certain examples, wherein the x-y area of the object being built decreases as you move upward along the build (z) axis, “smart advancing” may be used wherein the free edge of the composite material (e.g., free edge 261 in FIG. 1E) is advanced to the edge of the cross-section of the object being built instead of to the edge of the build envelope. This technique is beneficial because it reduces the amount of laminating material 42 comprising waste sections as the sections between the edge of the cross-section and the edge of the build envelope along the travel (x) axis will be waste. However, the technique is not used when the x-y area does not continually decrease as you move upward along the build (z) axis because some amount of waste section will be required beyond the object cross-section to act as a support for layers higher up in the object which extend beyond the travel (x) axis edge of lower layers in the object.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. An apparatus for making a laminated three-dimensional object from a composite material, comprising:
a build platform movable along a build axis and defining a build envelope perpendicular to the build axis;
a source of a composite material operable to provide composite material to the build envelope, wherein the composite material comprises a thermoplastic or thermosetting material;
a lamination assembly comprising a pressure roller that is movable along a travel axis and operable to laminate adjacent layers of the composite material to one another;
a cutting assembly comprising a blade for cutting a pattern into the composite material based on computer data representative of the three-dimensional object; and
a printhead movable at least along the travel axis and comprising a plurality of openings arranged along a printing axis, wherein each opening is in selective fluid communication with an adhesion reducing material.

2. The apparatus of claim 1, further comprising a controller operatively connected to the printhead, wherein the controller comprises a processor and a computer readable medium having computer executable instructions stored thereon, such that when executed by the processor the computer executable instructions cause the printhead to print a pattern of the adhesion reducing material corresponding to the computer data representative of the three-dimensional object.

3. The apparatus of claim 1, wherein the printhead is movable along the printing axis.

4. The apparatus of claim 1, wherein the composite material comprises a pre-peg having a plurality of fibers embedded in the thermoplastic or thermoset material, wherein the fibers are continuous unidirectional, continuous bidirectional, continuous multidirectional, or random discontinuous fibers.

5. The apparatus of claim 1, wherein the source of composite material comprises a roll of composite material having a free end, the apparatus further comprises a free end advancement system comprising at least one gripper configured to selectively grip the free end of the composite material and move the free end along the travel axis.

6. The apparatus of claim 1, wherein the cutting assembly blade has a length axis along the build axis, and the blade is rotatable about its length axis and reciprocatable along its length.

7. The apparatus of claim 1, wherein the composite material comprises a pre-peg having a plurality of anisotropic fibers and the build platform is selectively rotatable to a plurality of rotational positions about an axis of rotation that is parallel to the build axis.

8. The apparatus of claim 7, further comprising a controller operatively connected to the build platform, wherein the controller comprises a processor and a non-transient computer readable medium having computer executable instructions stored thereon, and when executed by the processor, the computer executable instructions cause the build platform to rotate by a selected amount following the lamination of one layer of the composite material and before the lamination of a next layer of the composite material.

9. The apparatus of claim 8, wherein when executed by the processor, the computer executable instructions translate object data for a current object layer from one rotational orientation of the build platform to the rotation defined by the selected amount.

10. The apparatus of claim 1, further comprising a controller operatively connected to the cutter and which is operable to cause the cutting assembly to move in a pattern corresponding to the computer data representative of the three-dimensional object.

11. The apparatus of claim 1, wherein the printhead is in fixed spatial relationship to the blade.

12. The apparatus of claim 1, wherein the pressure roller is rotatable about an axis of rotation and positioned above the build platform along the build axis, the pressure roller is operable to travel along the travel axis as it rotates about its axis of rotation, the lamination assembly further comprises at least one preheat heater, and the at least one preheat heater is spaced apart from the pressure roller along the travel axis and between the pressure roller axis of rotation and the build platform along the build axis.

13. The apparatus of claim 12, wherein the lamination assembly further comprises a guide roller that is rotatable about an axis of rotation, where the guide roller axis of rotation is spaced apart from the pressure roller axis of rotation along the travel axis and the build axis.

14. The apparatus of claim 13, wherein the pressure roller has an external surface that is selectively heatable in different regions along the external surface.

15. The apparatus of claim 12, wherein the at least one preheat heater comprises at least one infrared heater or inductive heater.

16. An apparatus for making a laminated three-dimensional object from a composite material, comprising:
a build platform that is movable along a build axis;
a lamination assembly comprising a pressure roller sub-assembly that is movable along a travel axis, the pressure roller sub-assembly comprising a pressure roller that is rotatable about an axis of rotation and positioned above the build platform along the build axis, wherein the pressure roller is operable to travel along a travel axis as it rotates about its axis of rotation, the pressure roller sub-assembly further comprises at least one preheat heater, and the at least one preheat heater is spaced apart from the pressure roller along the travel axis and between the pressure roller axis of rotation and the build platform along the build axis.

17. The apparatus of claim 16, wherein the pressure roller sub-assembly further comprises a guide roller that is rotatable about an axis of rotation, the guide roller axis of rotation is spaced apart from the pressure roller axis of rotation along the travel axis and the build axis.

18. The apparatus of claim 16, wherein the pressure roller has an external surface that is a selectively heatable.

19. The apparatus of claim 16, wherein the at least one preheat heater comprises an infrared heater.

20. The apparatus of claim 16, wherein the at least one preheater comprises three preheaters, a first two of the three preheaters are spaced apart from one another along the travel axis but not the build axis, and a third of the three preheaters is spaced apart from the first two of the preheaters along the build axis and located between the first two of the preheaters along the travel axis.

21. The apparatus of claim 16, further comprising a previously laminated layer of the composite material having a first surface and a second surface opposite the first surface of the previously laminated layer, the apparatus further comprising a currently laminated layer of composite material having a first surface and a second surface opposite the first surface of the currently laminated layer, wherein first surface of the currently laminated layer engages the pressure roller, a second surface of the currently laminated layer engages the guide roller and the first surface of the previously laminated layer, and the at least one preheat heater is positioned to direct infrared energy to the second surface of the currently laminated layer and the first surface of the previously laminated layer.

22. The apparatus of claim 16, further comprising a cutting assembly having a blade, wherein the cutting assembly is operable to cut an object section pattern into the composite material based on computer data representative of the three-dimensional object.

23. The apparatus of claim 16, further comprising a printhead movable along the travel axis and comprising a plurality of openings arranged along a printing axis, wherein each opening is in selective fluid communication with an adhesion reducing material.

24. The apparatus of claim 16, wherein the source of composite material comprises a roll of composite material having a free end, the apparatus further comprises a free end advancement system comprising a gripper configured to selectively grip the free end of the composite material and move the free end along the travel axis.

25. The apparatus of claim 24, wherein the lamination assembly comprises a frame, and the pressure roller sub-assembly slidably engages the frame to travel along the travel axis and is pivotable to rotate the pressure roller away from the frame and the build platform and the guide roller away from the frame and toward the build platform thereby allowing the gripper to pass the lamination assembly along the travel axis.

26. A method of making a laminated three-dimensional object from a composite material comprising a thermoplastic or thermosetting binder, the method comprising:
providing a first layer of the composite material;
cutting the first layer to form an object section, a waste section, and a first portion of an interface between the object section and the waste section while simultaneously dispensing an adhesion reducing material along a second portion of the interface;
cutting the waste section of the first layer into pieces that are removable from the object section of the first layer;
applying a next layer of the composite material on the first layer while applying heat and pressure to the next layer, thereby bonding the next layer to the first layer except along the interface.

27. The method of claim 26, wherein the step of dispensing an adhesion reducing material along the second portion of the interface comprises providing a printhead having a plurality of orifices in selective fluid communication with the adhesion reducing material, and dispensing the adhesion reducing material from selected ones of the orifices while traversing the printhead along a first axis.

28. The method of claim 27, wherein the step of dispensing the adhesion reducing material from selected ones of the orifices while traversing the printhead along a first axis also comprises dispensing the adhesion reducing material from selected ones of the orifices while traversing the printhead along a second axis

29. The method of claim 26, further comprising forming the next layer into an object section and a waste section.

30. The method of claim 29, further comprising removing the first layer waste section from the previous layer object section and the next layer waste section from the next layer object section.

31. The method of claim 29, wherein the forming step comprises cutting a pattern into the composite material that defines the object section based on computer data representative of the three-dimensional object and cutting the waste section into pieces that are separable from the object section.

32. The method of claim 26, wherein the adhesive has a glass transition temperature, and the method further comprises cooling the adhesive of the next layer below the glass transition temperature.

33. The method of claim 26, wherein the first layer has a first surface facing a build platform and a second surface facing away from the build platform, the next layer has a first surface facing the second surface of the previous layer and a second surface facing away from the previous layer, and the method further comprises heating the first surface of the next layer to a temperature no lower than a lamination temperature.

34. The method of claim 33, wherein the second surface of the first layer comprises a region in the first layer waste section that is in facing opposition to an object region in the first surface of the next layer object section, and the method further comprises dispensing the adhesion reducing material in the previous layer waste section region.

35. The method of claim 34, wherein the step of dispensing the adhesion reducing material on the region in the first layer waste section region comprises dispensing the adhesion reducing material in a continuous pattern.

36. The method of claim 34, wherein the step of dispensing the adhesion reducing material on the region in the first layer waste section region comprises dispensing the adhesion reducing material in a discontinuous pattern.

37. The method of claim 34, wherein the step of dispensing the adhesion reducing material in the first layer waste section comprises dispensing the adhesion reducing material in a central portion of the first layer waste section region but not in an edge portion of the first layer waste section region.

38. The method of claim 33, wherein the second surface of the previous layer comprises a region in the first layer object section that is in facing opposition to a waste region in the next layer object section, and the method further comprises dispensing the adhesion reducing material on the object region in the previous layer waste section.

39. The method of claim 38, wherein the step of dispensing the adhesion reducing material in the first layer object section region comprises dispensing the adhesion reducing material in a central portion of the first layer object region but not in an edge portion of the first layer object section region.

40. The method of claim 26, wherein the step of applying the next layer on the first layer comprises rolling a pressure roller over the next layer.

41. The method of claim 26, wherein the first layer is provided on a build platform movable along a build axis, the step of providing a first layer of the composite material comprises providing a source of the composite material having a free edge with a length along a first axis, the composite material comprises fibers having lengths with an orientation relative to the free edge, and the method further comprises rotating the build platform in a plane perpendicular to the build axis so that following the step of applying the next layer of the pre-peg material on the first layer of the composite material, the fiber lengths in the previous layer are not parallel to the fiber lengths in the next layer.

42. A method of making a three-dimensional object from a composite material comprising an adhesive, the method comprising:
providing a first layer of the composite material disposed on a build platform, the first layer of the composite material comprising fibers having lengths defining a length axis in a first rotational orientation;
rotating the build platform so that the length axis is in a second rotational orientation;
providing a second layer of the composite material comprising fibers having lengths defining a length axis in the first rotational orientation;
adhering the second layer of the composite material to the first layer of the composite material of the composite material so that the lengths of the fibers of the first layer are not parallel to the lengths of the fibers of the second layer.

43. The method of claim 42, further comprising the step of forming an object section and a waste section in the first layer.

44. The method of claim 43, further comprising the step of forming an object section and a waste section in the second layer such that a region of the first layer waste section faces a region of the second layer object region, and the method further comprises applying an adhesion reducing material to the region of the first layer waste section.

45. The method of claim 44, wherein the step of applying an adhesion reducing material to the region of the first layer waste section comprises applying the adhesion reducing material to a central portion of the region and not applying the adhesion reducing material to an edge portion of the region of the first layer waste section.

46. The method of claim 43, further comprising the step of forming an object section and a waste section in the second layer such that a region of the first layer object section faces a region of the second layer waste section, and the method further comprises applying an adhesion reducing material to the region of the first layer object section.

47. The method of claim 43, wherein the step of forming an object section and a waste section in the first layer comprises traversing a cutting blade having a length along a contour defining the object section while the cutting blade reciprocates along a build axis and rotates about an axis defined by the blade length.

48. The method of claim 43, wherein the object section and the waste section define an interface, and the method further comprises applying an adhesion reducing material along the interface.

49. The method of claim 48, further comprising providing a printhead having a plurality of orifices in selective fluid communication with a source of the adhesion reducing material, traversing the printhead along the interface while dispensing the adhesion reducing material from selected ones of the orifices.

50. The method of claim 42, wherein the first axis and the second axis are oriented at from about 20 degrees to about 60 degrees to one another.

51. The method of claim 42, wherein the first layer of the composite material has a first surface facing the build platform and a second surface facing away from the build platform, the second layer of the composite material has a first surface facing the second surface of the first layer, and a second surface facing away from the second surface of the first layer, and the method further comprises heating the first surface of the second layer until the adhesive reaches a lamination temperature.

52. A method of making a three-dimensional object by laminating a plurality of layers of a laminating material comprising a thermoplastic or thermosetting material, the method comprising:
providing a nominal layer thickness for a current layer of the laminating material;
laminating a current layer of the laminating material onto a previous layer of the laminating material, the current layer of the laminating material having an upper surface and a lower surface, the step of laminating the current layer comprising supplying an amount of heating energy from a heat source toward the lower surface of the current layer, and rolling a pressure roller having a longitudinal axis over the upper surface of the laminating material such that the pressure roller translates along a travel axis at a travel axis speed as it rotates about its longitudinal axis and applies a downward pressure along a build axis onto the upper surface of the laminating material;
determining an actual layer thickness;
laminating a next layer of the laminating material onto the current layer of the laminating material, the next layer of the laminating material having an upper surface and a lower surface, the lower surface facing the current layer, and the step of laminating the next layer of the laminating material onto the current layer of the laminating material comprising adjusting at least one of (i) a pressure of the pressure roller applied downward; (ii) an amount of heating energy supplied from the heat source, and (iii) the travel axis speed of the pressure roller.

53. The method of claim 52, wherein the at least one of (i) the pressure of the pressure roller applied downward, (ii) the amount of heating energy supplied from the heat source, and (iii) the travel axis speed of the pressure roller, comprises each one of (i) the pressure of the pressure roller applied downward, (ii) the amount of heating energy supplied from the heat source, and (iii) the travel axis speed of the pressure roller.

54. The method of claim 52, wherein the step of adjusting at least one of (i) the pressure of the pressure roller applied downward, (ii) the amount of heating energy supplied from the heat source, and (iii) the travel axis speed of the pressure roller comprises adjusting the pressure of the pressure roller applied downward by adjusting the distance by which the build platform descends before laminating the next layer relative to a distance by which the build platform descended before laminating the current layer.

55. The method of claim 52, wherein the step of adjusting at least one of (i) the pressure of the pressure roller applied downward, (ii) the amount of heating energy supplied from the heat source, and (iii) the travel axis speed of the pressure roller, comprises adjusting the current supplied to a preheater assembly comprising at least one infrared heater or at least one inductive heater

56. The method of claim 52, wherein the laminating material comprises a pre-peg.

57. The method of claim 52, wherein the step of determining an actual layer thickness for the current layer of laminating material comprises determining a sliding window average value of measured layer thicknesses for a previous set of laminated layers of the laminating material.

58. The method of claim 52, wherein the step of determining an actual layer thickness comprises determining an actual layer thickness for the current layer, and the step of determining the actual layer thickness for a current layer comprises determining a build axis position of an upper surface of the previous layer, determining a build axis position for the current layer, and determining a difference between the build axis position of the upper surface of the current layer and an upper surface of the next layer.

59. The method of claim 52, further comprising the step of forming an object section and a waste section in the current layer.

60. The method of claim 59, further comprising the step of rotating the current layer about an axis parallel to the build axis.

61. An apparatus for making a three-dimensional object from a composite material, comprising:
a build platform movable along a build axis and defining a build envelope perpendicular to the build axis, wherein the build platform is selectively rotatable about an axis of rotation parallel to the build axis;
a source of a composite material operable to provide composite material to the build envelope, wherein the composite material comprises a thermoplastic or thermosetting material;
a lamination assembly comprising a pressure roller that is movable along a travel axis and operable to laminate adjacent layers of the composite material to one another; and
a cutting assembly comprising a blade for cutting a pattern into the composite material based on computer data representative of the three-dimensional object.

62. The apparatus of claim 61, further comprising a source of adhesion reducing material.

63. The apparatus of claim 61, a printhead movable at least along the travel axis and comprising a plurality of openings arranged along a printing axis, wherein each opening is in selective fluid communication with an adhesion reducing material.

64. The apparatus of claim 61, further comprising a controller operatively connected to the build platform, wherein the controller comprises a processor and a non-transient computer readable medium having computer executable instructions stored thereon, and when executed by the processor, the computer executable instructions cause the build platform to rotate by a selected amount following the lamination of one layer of the composite material and before the lamination of a next layer of the composite material.

65. The apparatus of claim 64, wherein when executed by the processor, the computer executable instructions translate object data for a current object layer from one rotational orientation of the build platform to the rotation defined by the selected amount.

66. The apparatus of claim 61, wherein the composite material comprises continuous, anisotropic fibers.

67. The apparatus of claim 61, wherein the pressure roller is rotatable about an axis of rotation and positioned above the build platform along the build axis, the pressure roller is operable to travel along the travel axis as it rotates about its axis of rotation, the lamination assembly further comprises at least one preheat heater, and the at least one preheat heater is spaced apart from the pressure roller along the travel axis and between the pressure roller axis of rotation and the build platform along the build axis.

68. The apparatus of claim 67, wherein the lamination assembly further comprises a guide roller that is rotatable about an axis of rotation, where the guide roller axis of rotation is spaced apart from the pressure roller axis of rotation along the travel axis and the build axis.

69. The apparatus of claim 67, wherein the pressure roller has an external surface that is selectively heatable in different regions along the external surface.

70. The apparatus of claim 67, wherein the at least one preheat heater comprises at least one infrared heater or inductive heater.
